(19) United States
(12) Patent Application Publication
(10) Pub. No.: US 2013/0111514 A1
(43) Pub. Date: May 2, 2013

(54) SECOND SCREEN INTERACTIVE PLATFORM

(71) Applicant: Umami Co., Glen Ridge, NJ (US)

(72) Inventors: Bryan SLAVIN, Rockville, MD (US); Scott Rosenberg, Glen Ridge, NJ (US); Aron Glennon, New Windsor, NY (US)

(73) Assignee: Umami Co., Glen Ridge, NJ (US)

(21) Appl. No.: 13/621,277

(22) Filed: Sep. 16, 2012

Related U.S. Application Data
(60) Provisional application No. 61/535,511, filed on Sep. 16, 2011.

(51) Int. Cl. H04N 21/442

(52) U.S. Cl. CPC H04N 21/442
USPC 725/18

(57) ABSTRACT

Interactive digital media platform, methods and apparatus for detecting and dynamically synchronizing to media content (e.g., television (TV) programs or movies) that a viewer is watching while providing related content on a second screen for enhancing the viewer experience. In one embodiment, the primary content is determined by detecting an audio signal of the primary content via the second screen device; the audio signal may then be processed to generate a fingerprint for comparison with a data store of primary content. The primary content can be classified by various categories (e.g., unique program, advertising, repeat airing, theme song . . . ) and the classification used to aid in the identification and/or in selection of the content to be presented on the interactive second screen device. The system allows a substantially real time comparison and recognition of what primary content a viewer is watching on a first screen device and presentation to the user of content that is substantially synchronous to the viewer's location in the primary content. The viewer can actively engaged with the content presented and can share the content with others via social networking and the like.

### FIELD OF THE INVENTION

The present invention relates to an interactive digital media platform and more particularly to methods and apparatus for detecting and dynamically synchronizing to media content (e.g., television (TV) programs or movies) that a viewer is watching while providing related content on a second screen for enhancing the viewer experience.

### BACKGROUND

In general there is a large amount of related content that exists with respect to movies and television shows, e.g., reviews, ratings, trailers, movie tickets, fan gear, actor and actress biographies, crew biographies, celebrity stats, sound tracks, etc. However, there are no efficient, easy-to-use, automated mechanisms for delivering that related content to a viewer at a time and in a format that encourages the user to actively use the related context to enhance the viewing experience, e.g., concurrently review, search in depth and/or make purchasing decisions or take other actions based on that related content. Instead, the viewer is left on his own to actively seek out other media channels, e.g., websites, that provide related content and on these other channels is required to initiate a search based on what he or she can recall from the original programming that spurred the viewer's interest. These multiple steps, delays, and other burdens placed on the viewer mean they are less likely to be engaged in and take action on the programming and advertising they see, thereby limiting the return on the investment by the owner of the related content (e.g., movie studio and/or TV programmers).

### SUMMARY OF THE INVENTION

In one embodiment, the present invention provides a second screen interactive platform that can synchronize a viewer of a movie or TV programming (the primary content) is viewing on another source. In various embodiments, the second screen is a tablet computer, smartphone or laptop computer. In various embodiments, the primary content is being delivered on a television, a personal computer, a mobile device such as a smartphone or portable media player, or the like.

In one embodiment, the primary content (e.g., TV programming) that the viewer is watching is determined by detecting an audio signal of the primary content which the viewer is listening to. For example, the second screen device can detect (e.g., via a microphone) the audio signal and the second screen platform can determine the identity of the primary content. In this embodiment the audio signal (primary content) can be generated by substantially any source, and the provider of the second screen interactive platform need not be associated with nor licensed by the primary content provider. Similarly, the user is not required to take any active steps (other than start the second screen application) to identify what the viewer is watching on the other (primary content) device. The viewer is free to select from any of the available sources of primary content for viewing, and to randomly reselect (e.g., change TV channels, change media service providers, or change video display devices) without limitation.

In accordance with one embodiment of the invention, the second screen platform continuously tracks what the viewer is watching and provides related content which changes as the primary content being viewed changes. This continuous tracking can be in substantially real time to enable the delivery of related content to the viewer substantially concurrently with the primary content being viewed.

In one embodiment, the second screen platform captures an audio portion of the primary content that the viewer is watching, and from this captured audio content determines what is being viewed. In one example, this determination is made by audio fingerprinting, a passive technique whereby key elements or signatures are extracted from the detected audio to generate a sample fingerprint which is then compared against a known set of fingerprints generated (by the same or similar fingerprinting algorithm) to determine a match.

In one embodiment, the platform then transmits to the viewer on the second screen information relevant to the primary content being viewed. This information may include one or more of the following: identification of the primary content being viewed, a time or location marker of what is being viewed, additional information about the primary content, or the like.

In one embodiment, the second screen presentation is synchronized in time to that portion of the primary content currently or recently viewed by the viewer. In one example, the second screen presentation includes a plurality of time synchronized pages.

In one embodiment, the platform automatically advances the presentation through the pages without input from the viewer (i.e., a passive viewer mode). Alternatively, the viewer can himself engage the screen to interact with content or actively move through the content (Le., active viewer mode).

In one embodiment, a page on the second screen presentation can be a direct connection to a web page of related content. Alternatively, the second screen page can link to another page of related content provided by the platform itself.

In yet another embodiment, the presentation on the second screen may be asynchronous with respect to time, e.g., no time indicator. In one example, the presentation may include one or more pages directed to the general subject matter of the primary content, the cast, multiple episodes, and/or a social networking forum.

Preferably, the second screen presentation compels the viewer to interact with the presentation. This interaction may include the viewer requesting more information, conducting a search, reviewing advertisements, scheduling a future event, contributing to the related content, interacting with other viewers and/or non-viewers having an interest in related content, social networking associated with the primary or related content, purchasing services or goods as a result of such interaction, or the like.

In one embodiment, the second screen platform works with primary content comprising a live broadcast, streaming or stored video content.

In one embodiment of the invention, a second screen interactive content delivery system is provided comprising:
a portable interactive second screen device for use while watching a primary content comprising television programming on a first screen device, the second screen device having an audio analyzer for audibly detecting an audio portion of the currently viewed primary content on the first screen device and the second screen device having an interactive display screen for presenting interactive content contextually related to the detected primary content,
the second screen device including a processor executing a first stored program for communicating with an identification process that determines a match between a detected primary content and a known primary content, wherein the first stored program operates to:
process the detected audio portion and communicate the processed audio portion to the identification process to determine a match that identifies the detected primary content; and
based on that identification, process and present on the display screen an interactive content that is contextually related to the detected primary content.

In another embodiment, the first stored program utilizes a fingerprinting algorithm for processing the detected audio portion.

In another embodiment, the known primary content comprises fingerprints and for each fingerprint an associated television program and a time offset within the program.

In another embodiment, the interactive content is presented as a series of web-based pages synchronized in time with respect to the detected primary content.

In another embodiment, the series of pages are synchronized to time codes in the television programming.

In another embodiment, the series of pages can be scrolled via the interactive display screen.

In another embodiment, individual pages can be selected via the interactive display screen.

In another embodiment, the series of pages comprises a flipbook, organized horizontally, vertically or stacked, and in order of the time codes.

In another embodiment, one or more asynchronous pages is presented at the beginning and/or end of the series of synchronized pages.

In another embodiment, the first stored program operates to automatically after a designed time period, or in response to a communication from a user selectable option on the display screen, return to a page having a time code closest to but not exceeding a current time.

In another embodiment, each page is displayed only after its associated time code has passed in the primary content being detected.

In another embodiment, the first stored program operates to conceal a page until after its associated time code has passed in the primary content begin detected, and presents a user selectable option on the display screen to reveal the page.

In another embodiment, the first stored program operates to automatically advance through the time synchronized pages presented on the interactive display screen.

In another embodiment, the first stored program halts the automatic advancement in response to an input signal from the display screen indicating a user interaction with the display screen.

In another embodiment, the first stored program communicates as a client with a fingerprinting identification server external to the second screen device for determining a match of a detected primary contact and a stored primary contact.

In another embodiment, the client and server accumulate and share matching information over several request-response transactions to determine a match.

In another embodiment, the server executes a second stored program that sends a cookie to the client with partial match information.

In another embodiment, the first stored program receives the cookie and sends the cookie back to the server along with a subsequently detected audio portion.

In another embodiment, wherein the first stored program communicates with a fingerprinting identification service to search for a match across a data store of known primary content, and once a match is identified, subsequent searches for matches with subsequent detected audio portions are performed within a neighborhood of the identified match.

In another embodiment, the neighborhood is a range of time prior to and after to the matched primary content.

In another embodiment, the second screen device is Internet-enabled for communicating with the identification process and source(s) of the interactive content.

In another embodiment, the second screen device includes a browser process communicating with an external web server for aggregating the interactive content.

In another embodiment, the second screen device includes a web browser, a data store of detected primary content, and an inter-process interface communicating with the browser and data store for processing the interactive content.

In another embodiment, the first stored program on the second screen device includes a fingerprinting generation process communicating with an external web service that stores detected primary content.

In another embodiment, the second screen device includes a browser process having a fingerprinting generation process embedded in the browser process.

In another embodiment, the second screen device includes a fingerprinting process and a browser process embedded in a primary application stored on the second screen device.

In another embodiment, the identification process utilizes metadata of the known primary content and the detected audio portion to determine a match.

In another embodiment, the metadata comprises a characteristic of the known primary content including one or more of:
Unique Program;
Advertising;
Repeat Airing of a Program;
Theme Song;
Silence;
Noise;
Speaking.

In another embodiment, the first stored program utilizes the metadata to determine one or more of:
a program boundary;
an advertisement boundary.

In another embodiment, the first screen device comprises a television, a personal computer, a Smartphone, a portable media player, a cable or satellite set-top box, an Internet-enabled streaming device, a gaming device, or a DVD/blue ray device.

In another embodiment, the second screen device comprises a tablet computer, a Smartphone, a laptop computer, or a portable media player.

In another embodiment, the second screen device continually tracks the detected audio portion and the first stored program presents in substantially real time interactive content which changes as the detected audio portion changes.

In another embodiment, once a match is determined the identification service sends a portion of the data store defined by the neighborhood to the second screen device which portion is then stored on the second screen device for use locally on the second screen device in subsequent identification searches.

In another embodiment, the second screen device includes a user selectable input and the first stored program responds to a communication from the user selectable input to advance through the time synchronized pages.

In another embodiment, the first stored program operates to process communications from the user selectable input including one or more of:
requesting more information;
conducting a search;
viewing advertisements;
scheduling a future event;
contributing to the interactive content;
interacting with other viewers and/or non-viewers having an interest in the primary or interactive content;
social networking associated with the primary or interactive content;
purchasing services or goods.

In another embodiment, the primary content comprises a live broadcast, streaming content, or stored video content.

In another embodiment, the interactive content comprises one or more of a direct connection to a web page, and a link to a web page.

In one embodiment of the invention, a method is provided for substantially real time comparison and recognition of what primary content a viewer is watching on a first screen device comprising:
a. detecting on a portable interactive second screen device an audio signal from a primary video content that a viewer is watching on a first screen device;
b. identifying the primary video content utilizing the detected audio signal or a representation thereof for comparison with a primary content detection signal or representation thereof;
c. based on the identification, presenting content on the second screen device substantially synchronous to the viewer's location in the primary content.

In another embodiment, the method includes utilizing metadata of the primary content detection signal or representation thereof in the step of identifying the detected primary content or in a step of selecting the content presented on the second screen device.

In another embodiment, the method includes the step of extracting information from one or more content streams to generate the metadata.

In another embodiment, the streams comprise one or more of video, audio and closed captioning of the primary content.

In one embodiment of the invention, a method is provided of substantially real time sharing of video content a viewer is watching on a first screen device comprising:
a. detecting on a portable interactive second screen device an audio signal from a primary video content that a viewer is watching on a first screen device;
b. identifying the primary video content utilizing the detected audio signal or a representation thereof for comparison with a primary content detection signal or representation thereof;
c. based on the identification, presenting content on the second screen device substantially synchronous to the viewer's location in the primary content;
d. the content presented on the second screen device including one or more images or videos from the primary content that are substantially synchronous in time to the viewer's location in the primary content and a user selectable input for sharing the content via a social network, email or other communications protocol.

In another embodiment the method includes:
e. storing audio fingerprints of the primary video content in a data store with an associated content identifier and time code that identifies a location in the primary content;
f. storing video and/or images from the primary content in a data store with an associated content identifier and time code that identifies a location in the primary content; and
g. utilizing the audio fingerprints in the identifying step and utilizing the video and/or images that correspond to the time code of the identified audio fingerprint or within a designated time range before and/or after that time code to select the content presented on the second screen.

These and other embodiments of the invention will be more fully understood with regard to the following detailed description and accompanying drawings.

### BRIEF DESCRIPTION OF THE DRAWINGS

FIG. 1 is a schematic high level system architectural view of one embodiment of the invention for providing interactive second screen content;

FIG. 2 is a block diagram illustrating communications between the primary content provider, viewer, and second screen content provider;

FIG. 3 is a screenshot of a first page of a series of pages of related content for viewing on a second screen, referred to herein as a “flipbook”, the flipbook providing related content for a TV show (primary content) being watched by the viewer on a first screen;

FIG. 4 is a second page of the flipbook of FIG. 3 with content summarizing the top stories of the TV show;

FIG. 5 is a third page of the flipbook of FIG. 3 with content relating to a particular story of the TV show;

FIG. 6 is a final page of a different flipbook with interactive content asking the viewer to respond to a question;

FIG. 7 is an initial screenshot (page) of a second screen presentation according to another embodiment of the invention, wherein the initial page identifies the TV show (primary content) being watched by the viewer;

FIG. 8 is a Home page of the embodiment of FIG. 7;

FIG. 9 is a schematic illustration of the functions of various icons and buttons on a second screen device for navigating the second screen presentation according to the embodiment of FIG. 7;

FIG. 10 is a News page of the embodiment of FIG. 7, including a search function, where common search terms are listed but a user is also permitted to type a search term in the upper left search box;

FIG. 11 is a Social page of the embodiment of FIG. 7, where the user can view and participate in conversation about the TV program presently being viewed;

FIG. 12 is a Cast page of the embodiment of FIG. 7, where the user can view information about the cast in the TV program presently being viewed;

FIG. 13 is a flow chart of a process of the invention;

FIG. 14 is a flow chart of another process of the invention;

FIG. 15 is a flow chart of another process of the invention;

FIG. 16 is a flow chart of another process of the invention;

FIG. 17 is a flow chart of another process of the invention;

FIG. 18 is a schematic diagram illustrating a computer network for implementing one embodiment of the invention wherein a page presented on a second screen is assembled from data stored on a second screen content provider database and from data received from third-party content providers;

FIG. 19 is a block diagram illustrating communications between components according to one embodiment of the invention, wherein a second screen device is running both a fingerprinting process and a web browser;

FIG. 20 is a block diagram illustrating communications between components of another embodiment of the invention similar to FIG. 19, but wherein the fingerprinting process posts the primary content program and positional information to a web service that is also available to the browser;

FIG. 21 is a block diagram illustrating communications between components of another embodiment of the invention similar to FIG. 19, but wherein the fingerprinting process is embedded directly into the browser;

FIG. 22 is a block diagram illustrating communications between components of another embodiment of the invention similar to FIG. 19, but wherein a primary application embeds both the fingerprinting process and the web browser capability;

FIG. 23 is a flow chart of another process of the invention, wherein an external process, after determining a match, downloads to the second screen device primary content data in the neighborhood of the match, allowing subsequent searches for a match to be processed locally on the second screen device;

FIG. 24 is a schematic diagram illustrating the components and processes of another embodiment of the invention wherein primary content metadata includes classification information determined by a classification process for use during the identification (matching) process; and

FIG. 25 is a schematic diagram illustrating the components and processes of another embodiment of the invention including video and/or images that can be provided as content on the second screen device and shared with others (e.g., via social networking).

### DETAILED DESCRIPTION

Various embodiments of the present invention are now described with reference to the drawings. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The present invention may also be illustrated as a flow chart of a process of the invention. While, for the purposes of simplicity of explanation, the one or more methodologies shown therein, e.g., in the form of a flow chart, are described as a series of acts, it is to be understood and appreciated that the present invention is not limited by the order of acts, as some acts may, in accordance with the present invention, occur in a different order and/or concurrent with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

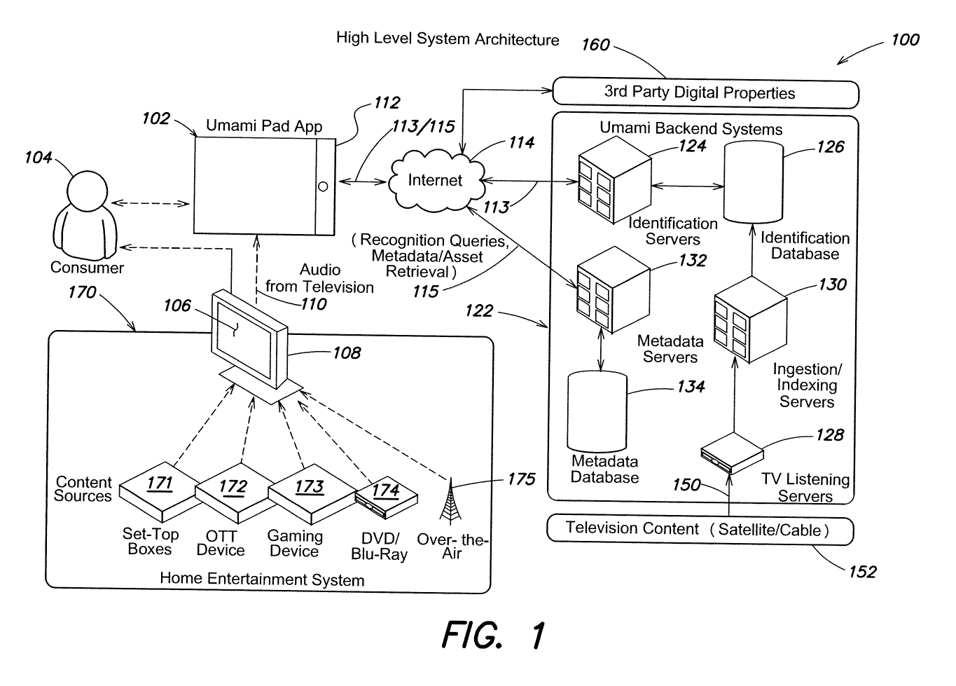

FIG. 1 illustrates a highlevel system architecture 100 for one embodiment of a second screen platform according to the invention. In this embodiment, the second screen platform is implemented as an application for viewing on a second screen device, here a tablet computer 102, e.g., an iPad (iPad is a registered trademark of Apple, Inc., Cupertino, Calif.). A viewer 104 (e.g., consumer) is shown interacting with the tablet while viewing primary content 106 on a first screen device, here a television screen 108. Audio 110 from the television is detected by a microphone 112 in the tablet, optionally processed at the tablet 102, and sent as a signal in processed or unprocessed form over the Internet 114 to the second screen platform service provider 120. In this embodiment, the second screen provider maintains various backend systems 122 for processing data and communicating with the viewer's tablet via the Internet. One or more identification servers124 receive from the tablet a processed or unprocessed audio sampling signal 113 regarding the primary content 106 being viewed on screen 108. This signal is processed by software running on the identification server(s) and compared to data stored in a database of stored identification information (the identification database 126). In this example, the identification database contains records of television programming content received for example via a satellite or cable distributor 152. This television programming (primary content) is received by the TV listening servers 128, and then processed (e.g., fingerprinted and indexed) by the ingestion/indexing servers 130, the results of which are stored in the identification database 126. This enables the second screen provider to quickly (in substantially real time) compare and identify the primary content being viewed by the consumer, e.g., by a comparison of the second screen provider's stored television content in the identification database, with the audio sampling signal 113 sent from the viewer's tablet 102.

FIG. 1 further illustrates the second screen provider's metadata servers 132, and connected metadata database 134, for receiving, processing and responding to queries 115 sent via the Internet 114 from the viewer's tablet 102. These queries may result from the viewer's interaction with the related content on the tablet, such as a request for additional related content, access to a web page, a search request, connection to a social network forum, connection to a purchasing site and/or other requests.

FIG. 1 further illustrates a plurality of external digital properties 160 that the tablet application and second screen provider can access for enhancing the viewer experience. Examples thereof include search engines, social networking sites, on-line databases (e.g., Internet Movie Database, Wikipedia),etc.

FIG. 1 further illustrates multiple alternative delivery devices 170 for delivering the primary content to the consumer's first screen device 108. For example, the primary content delivery device may be a set top box 171, an Internet-connected video streaming device 172, a gaming device 173, a DVD/Blu-ray device 174, or an over-the-air (e.g., antenna) device 175.

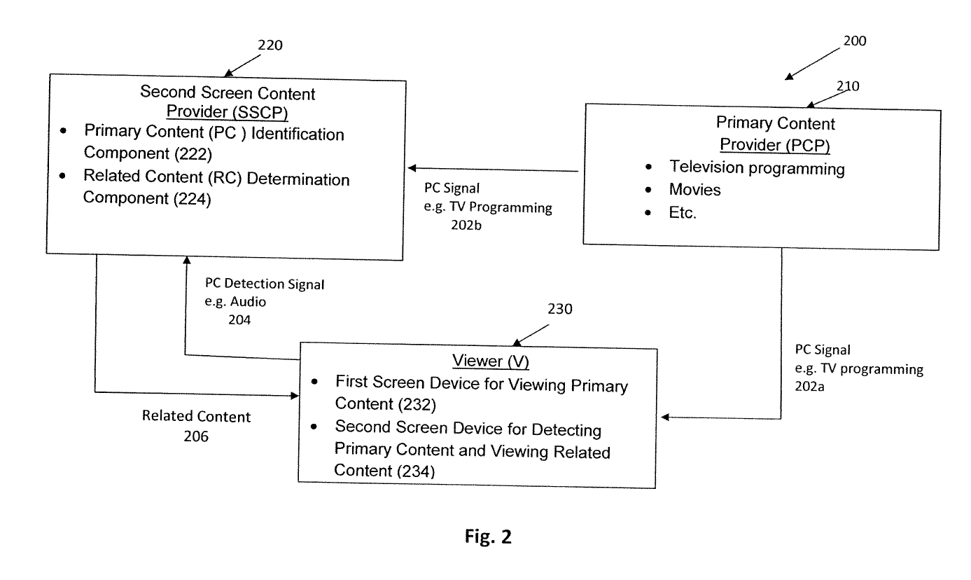

FIG. 2 illustrates schematically communications 200 between three different participants, the primary content provider (PCP) 210, the second screen content provider (SSCP) 220 and the viewer 230, and their perspective views according to various embodiments of the invention. The three participants correspond to the entities 152, 120 and 104 respectively in FIG. 1. From the perspective of the viewer 230, the viewer is watching primary video content, e.g., TV programming, on a first screen 232 and is viewing and/or interacting with the related content on a second screen 234. The viewer receives the primary content (TV programming 202a) from any of various programming sources, and the viewer's second screen communicates with a second screen content provider (SSCP) 220. The second screen (SS) device 234 also detects the primary content (PC) on the first screen device 232 and sends a signal to the SSCP 220 for identification of the primary content. From the perspective of the primary content provider 210, the primary content 202a, 202b is sent, in processed or unprocessed form, and either directly or indirectly, to both the viewer 230 and the SSCP 220. The SSCP may receive or have already stored additional information (metadata) concerning the primary content. The SSCP's identification component 222 utilizes the signal 202b (or a representation thereof, e.g., a fingerprint) for comparison with a primary content detection signal 204 (e.g., audio sampling or other signal/message, or a representation thereof, e.g., a fingerprint) received from the viewer's second screen device 234 (or generated by the SSCP in response to a detection signal received from the SS device) in order to identify what primary content the viewer is watching. Based on that identification, the SSCP's determination component 224 determines what related content to send to the second screen device 234.

Thus, the SSCP 220 is responsible for processing the detected signal from the viewer's first screen and determining the related content, enabling a substantially real time comparison and recognition of what primary content the viewer is watching.

This processing and determination can be implemented in various methods according to the invention. In one embodiment, the client (second screen) and server (SSCP Platform) use symmetric fingerprinting algorithms to generate fingerprints of primary content that are used in a matching process to identify what the viewer is watching on the second screen. In one embodiment, the SSCP (backend listening servers and ingestion/indexing servers) receive live broadcast video, and optionally metadata concerning that video (e.g., show description, cast, episode, gossip, news), together with or separate from the live broadcast video, and generate fingerprints of the video content and optionally the SSCP generates further metadata concerning the video content, which the SSCP then stores (e.g., fingerprints, received metadata, generated metadata) in the SSCP servers. Then, when the SSCP receives a detection signal from the second screen device, it uses the same or similar fingerprinting algorithm to generate fingerprints which are then compared to the fingerprints (and optionally metadata) stored in the SSCP servers. The SSCP determines a match between the respective fingerprints alone and/or on the basis of the metadata. In some examples, described below, the SSCP uses the metadata in the matching process. In one example, the metadata includes classification information concerning the primary content, such as whether the primary content is a distinguishing characteristic, e.g., unique in the database or whether it is repetitive (Le., recurrent) content. If it is classified as repetitive, the SSCP server may defer (reject) the determination of a match, and instead utilize further detection signals based upon distinguishing characteristics of the primary content. Alternatively, the metadata may be annotation information useful in selecting related content. For example, the metadata may identify the cast members or news relating to the show, which the SSCP then utilizes in the post match process for selecting the related content to send to the second screen device. These and other embodiments are discussed further below.

The following flow charts illustrate more specific embodiments for implementing the present invention.

### Method A (Viewer Perspective)

1. Viewer (e.g., on TV, computer) watching select primary content (e.g., TV programming) on first screen.
2. Viewer starts second screen application and second screen (SS) detects content.
3. SS sends (e.g., via Internet) signal or message regarding detected content to the second screen content provider (SSCP).
4. SSCP generates a viewer fingerprint (VF) for the detected content (e.g., audio fingerprinting algorithm).
5. SSCP compares viewer fingerprint to library of primary content (data and/or metadata) to identify the selected PC being watched by the viewer (e.g., similarity search).
6. SSCP selects second screen related content (selection may include previously stored content and/or content to be aggregated in real-time).
7. SSCP sends SS related content directly or indirectly (e.g., via third party related content providers) to viewer's second screen.
8. Second screen device presents SS related content to viewer (e.g., on tablet display).
9. Viewer views and/or interacts with SS related content on second screen device.

### Method B (SSCP Perspective)

1. SSCP receives primary content from primary content provider (e.g., directly or indirectly).
2. SSCP generates library of primary content (data or metadata)
3. SSCP compares viewer detection signal (e.g., viewer, fingerprint) to library contents to identify primary content being watched by viewer.
4. SSCP associates primary content to SS related content.
5. SSCP sends (directly or indirectly) SS related content to viewer's second screen device.

More specific examples of systems and methods for implementing the present invention are described below.

### Synchronizeronized Flipbook

In one embodiment the second screen interactive content is arranged as a series of pages (e.g., web-based pages) that can be swiped across the screen (e.g., left/right) to advance through the pages, herein referred to as a “flipbook”. An optional set of thumbnails or icons representing each page is presented underneath the pages, in the format of a “filmstrip”. By clicking on a particular icon on the filmstrip, the user can select the related page (of the flipbook) which is then presented on the second screen.

The individual pages of the flipbook may contain synchronizeronous or asynchronizeronous content. The synchronizeronous pages are designed to be shown to the user (viewer) at a specific point in the primary content (e.g., TV program), as the related content is specific to a particular portion of the program. In contrast, asynchronizeronous pages are designed to be of general interest throughout the program, and not necessarily at a specific portion of the program.

It is expected that the user may be viewing a program on the primary screen, other than at the time the primary content provider distributed (e.g., broadcast) that program. For example, the user may have recorded the program for later viewing, and/or acquired a stored version of the program from various third-party providers. To avoid displaying the synchronizeronous pages to the user prematurely, the synchronizeronous pages can be displayed on the second screen device according to different methods, for example:
a) being always visible even if the user has not reached that point in the program;
b) being hidden by default so that the user can ask for synchronizeronous pages to be revealed; and
c) being hidden by default so that the user cannot see the synchronizeronous pages until that point in the program is reached.

A useful feature according to one embodiment of the present invention is the ability to provide related content for reviewing in alternative user modes, namely active navigation of the second screen content and passive navigation of the second screen content. In the passive navigation mode, the user is not required to interact with the second screen device, but can simply view the second screen interface as desired, and interact therewith when desired. The second screen content provider enables such passive viewing by propelling the viewer through related content even if they are not interacting with the second screen. This automatic moving through pages, without requiring the user to do anything, generates page views and ad impressions for the second screen provider and third-party content providers. By default, the second screen interface may be provided in passive mode when the user enters the second screen interface. Then, when a user actively selects something on the second screen, the platform switches into active mode. Now, the automatic progression of the flipbook stops, and the user is redirected to another page based on the user selection. Later, if a user double taps for example on the page or otherwise signals that he wants to return to the current point in the primary content being viewed on the first screen, or if the user does not interact with the flipbook for some designated period of time, the second screen content returns to the most current live position (in the primary content) and to passive mode.

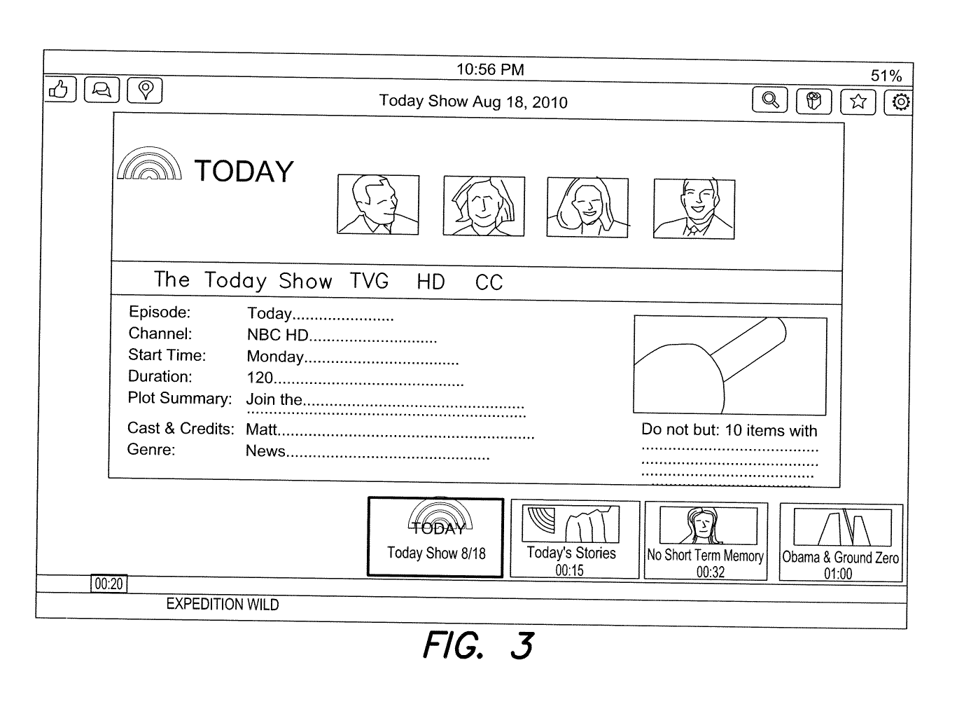

FIGS. 3-5 illustrate one embodiment of a flipbook, having both synchronizeronous and asynchronizeronous pages, and a filmstrip for moving between selected pages. In this example, FIGS. 3-5 illustrate three consecutive pages of a flipbook providing related content for a specific TV show, here one episode of The Today Show (“The Today Show” is a registered trademark of NBC Studios, New York, N.Y.). In the passive mode, the second screen automatically advances through these pages without the viewer having to interact with the second screen; this is the “passive” mode. Alternatively, the user can touch something on the page to switch into “active” mode, whereby the automatic progression of the flipbook stops and the second screen display changes to the specific related content selected by the user. Later, if the user double taps the timeline (here a slider bar provided below the filmstrip and showing the current time in the primary content being viewed) or otherwise signals that he wants to return to the most current page in the flipbook, or if the user does not interact with the flipbook for some specific (no-activity) period of time (e.g., 30 seconds), the second screen application returns the user to the most current (live) position in the flipbook and to passive mode. An advertisement is presented at the bottom of each page.

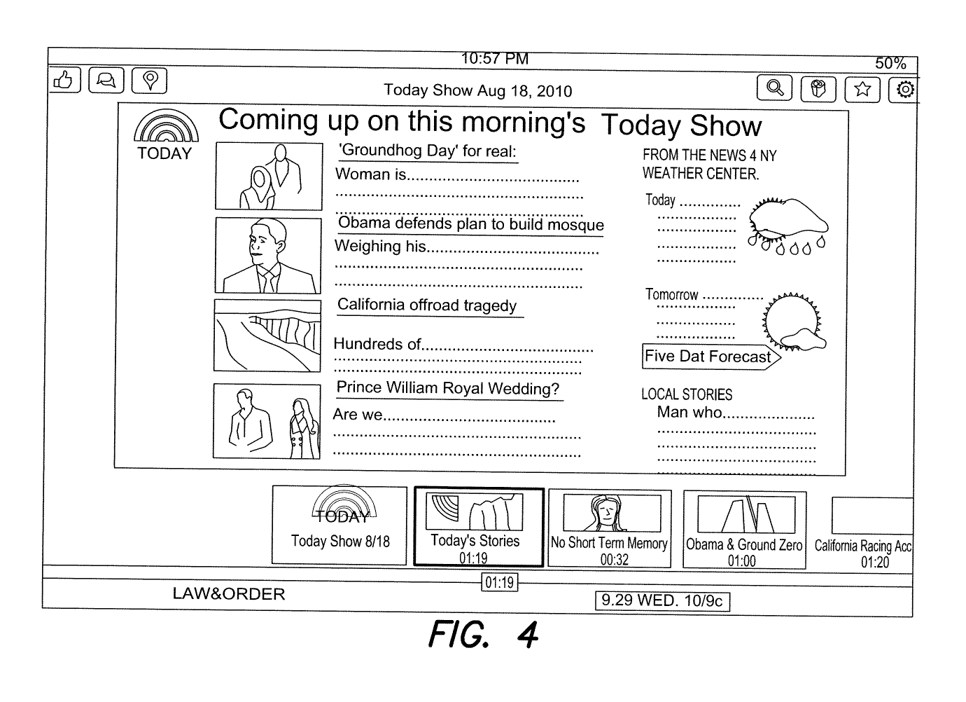

FIG. 3 illustrates a first (left-hand) page of the flipbook providing a summary of The Today Show episode being watched by the viewer. Because this page is of general interest and not specific to a particular portion of the show, it is referred to herein as an asynchronous window. The filmstrip appears at the bottom of the page running horizontally below the flipbook window. The filmstrip comprises a series of smaller icons identifying specific portions of The Today Show episode as they are represented in time order within the episode. In FIG. 3, the first (left-hand) icon is highlighted, thereby selecting the first (left-hand) page of the flipbook which is shown above the filmstrip in FIG. 3. In FIG. 4, the second icon is highlighted, and the selected second flipbook page is shown above. This page also contains synchronous content, namely a summary of the top stories and special reports being presented by the hosts at that moment in The Today Show episode. Each summary begins with a heading providing a link as another way to navigate directly to a related content specific to that story in the flipbook.

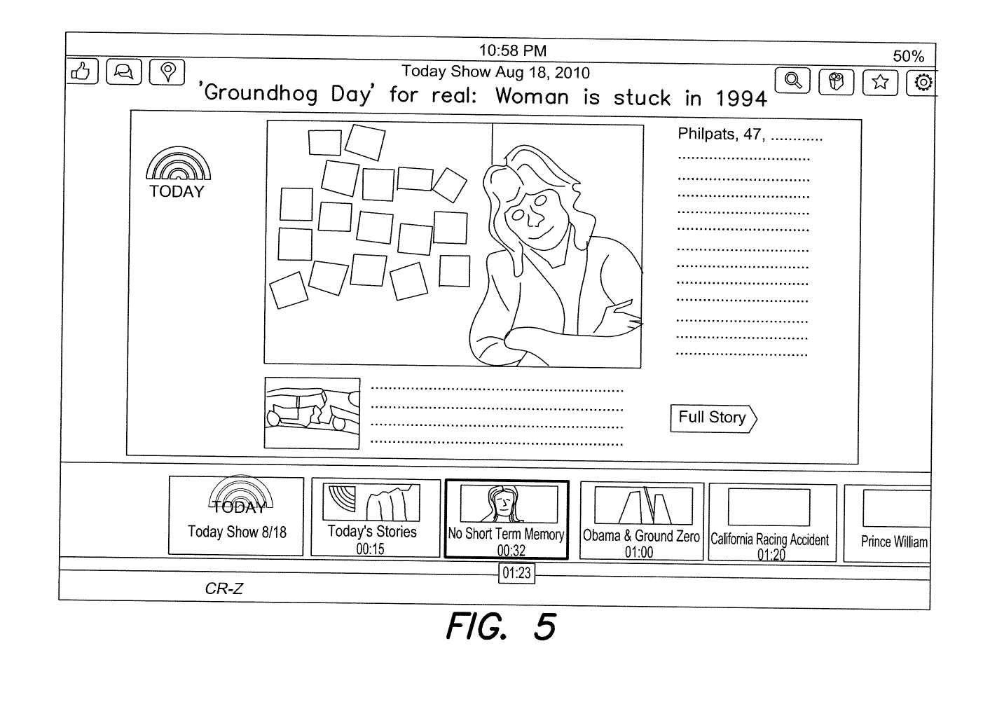

FIG. 5 shows the third icon highlighted and above the icon the flipbook page provides the related content for the specified story in The Today Show episode.

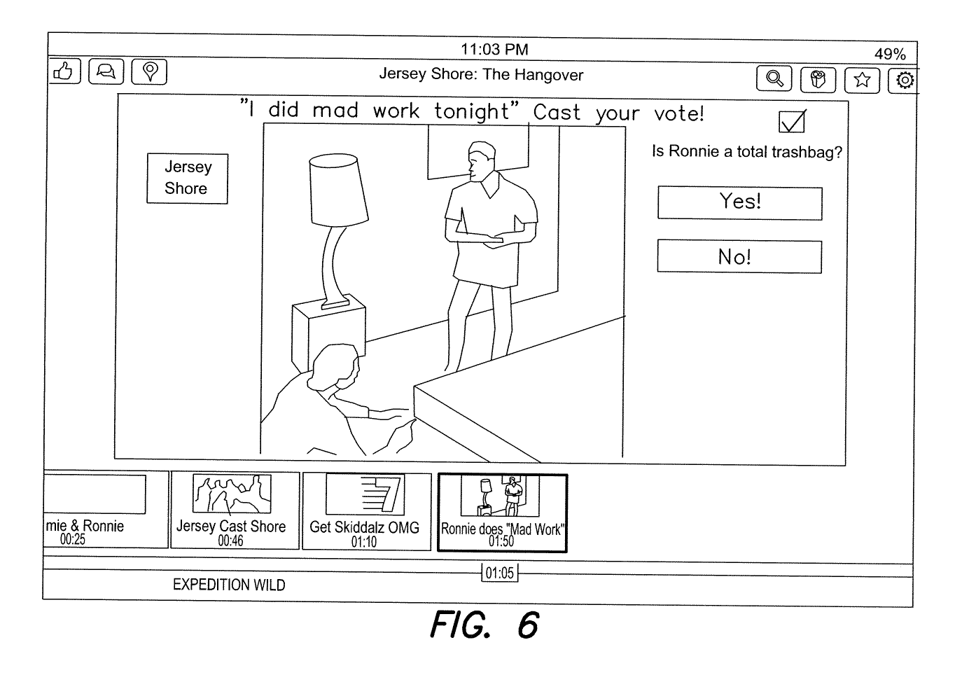

As another example, FIG. 6 illustrates for a different primary content, namely an episode of the TV program “Jersey Shore”, a last (right-hand) icon that is highlighted and the selected last (right-hand) webpage above the filmstrip. This flipbook page prompts interaction by the viewer, here asking the viewer to vote “yes” or “no” in response to a question relating to the TV show (primary content) just viewed. This page encourages the viewer to enter an active mode with the second screen device. Such viewer participation encourages future interaction, e.g., as the viewer may want to learn the results of the voting initiated by the question on this webpage.

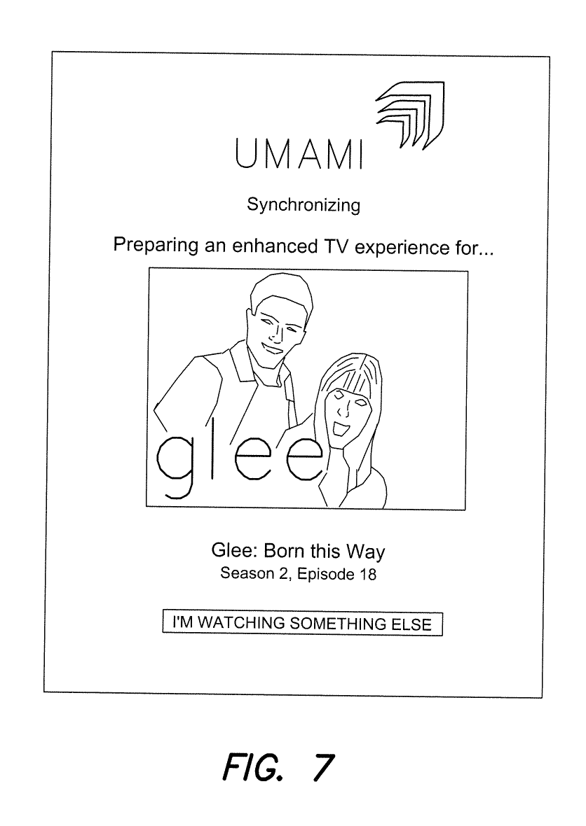

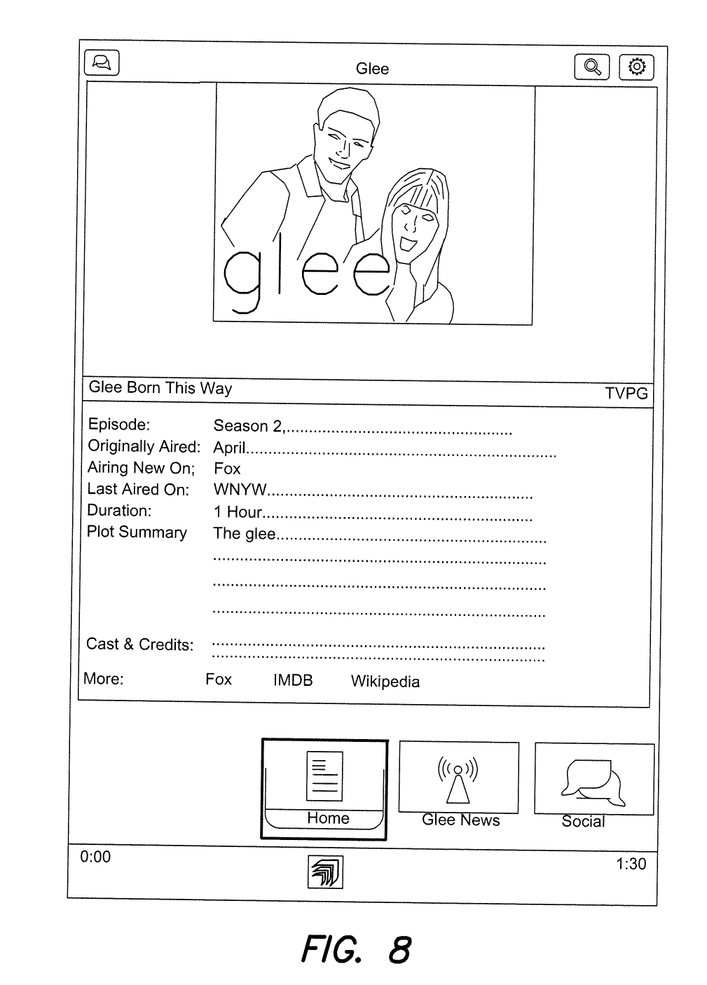

FIGS. 7-12 illustrate yet another embodiment of the invention encouraging viewer interaction with the second screen device (active mode). In one embodiment, the second screen device detects some portion of the primary content being viewed on the first screen, and the second screen interactive platform determines the viewer is now watching a specific TV episode of the television program “Glee”, more specifically the Season 2, Episode 18, entitled “Born this Way.” The second screen platform provides a display on the viewer's second screen as shown in FIG. 7. This display informs the user that the platform has recognized what the viewer is watching on the first screen, by identifying the specific program, and notifies the viewer that the second screen content related to this specific primary content is being prepared for the second screen device. The display also includes a button entitled “I'M WATCHING SOMETHING ELSE”, enabling the user to signal to the platform that the identified program on the display is not what the viewer is watching on the first screen, which signal causes the platform to repeat the step of detecting and determining what primary content is being viewed by the viewer. Assuming the specified content is correct, FIG. 8 next appears as a web-based page for the second screen. This cover or home page, is noted by the highlighted Home icon along the bottom edge of the page, and provides a summary of the show being watched. In addition to the episode name, it includes the episode number, the original air date, the primary content provider, the last air date, the show duration, a plot summary, and a list of cast and credits. Also provided are links to external digital properties (e.g., websites) that can provide additional related content concerning the primary content.

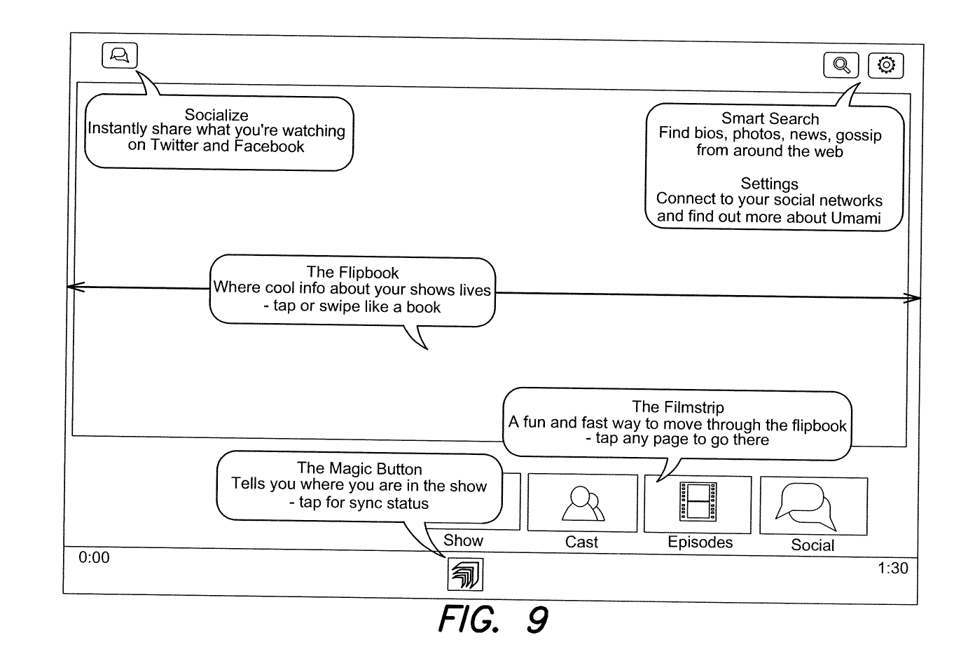

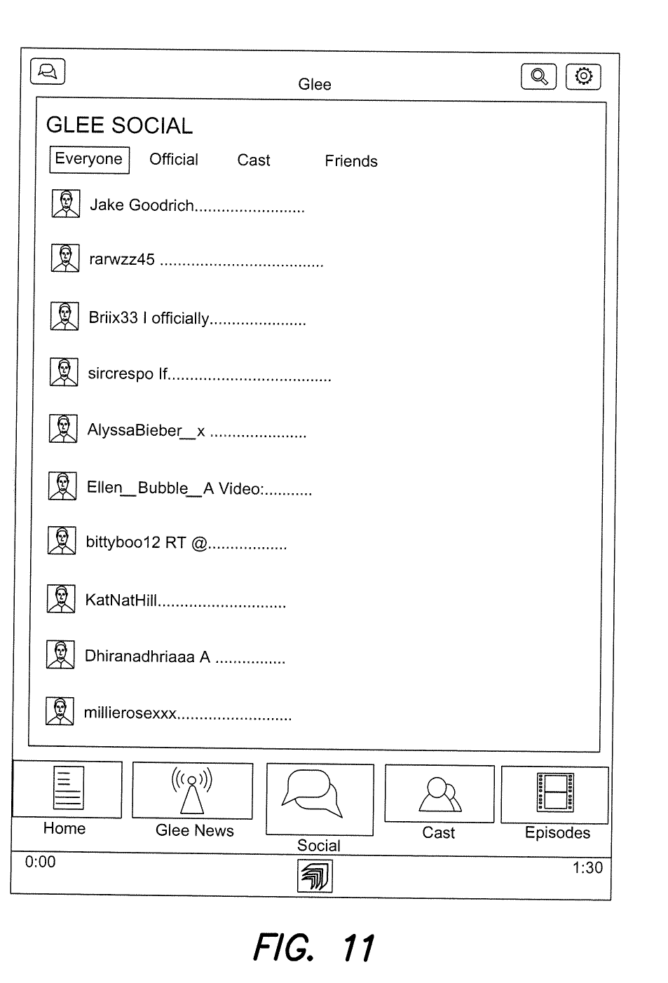

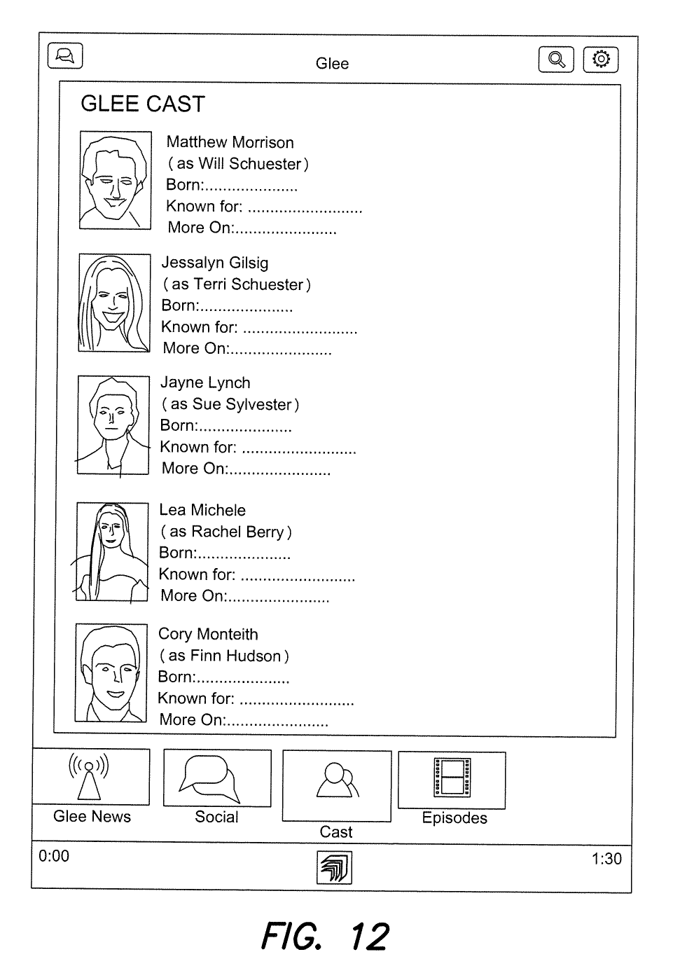

FIG. 9 illustrates multiple control options on the second screen user interface of this embodiment enabling the user to select from among various types of related content. At the upper left corner is a Socialize icon enabling the user to instantly share what primary content they are watching with others via various social networking platforms. In the upper right-hand corner is a Search icon enabling the user to conduct a search for further related content, such as for finding biographies, photos, news, and gossip concerning the show and/or cast. A Settings icon enables a user to connect to his or her social network and/or determine or change the settings on the second screen platform. A central window shows/selects a flipbook, as previously described. A lower-most central button at the bottom of the interface enables the user to determine sync status, enabling the user to determine where (what portion) of the show they are currently viewing on the primary screen device. A series of buttons along the lower edge of the page enable the user to select a page within the flipbook, with a general description of the program being viewed (e.g., FIG. 8), a Cast page (e.g., FIG. 12), an Episodes page (e.g., for selecting other episodes of the show), and a Social page (e.g., FIG. 11).

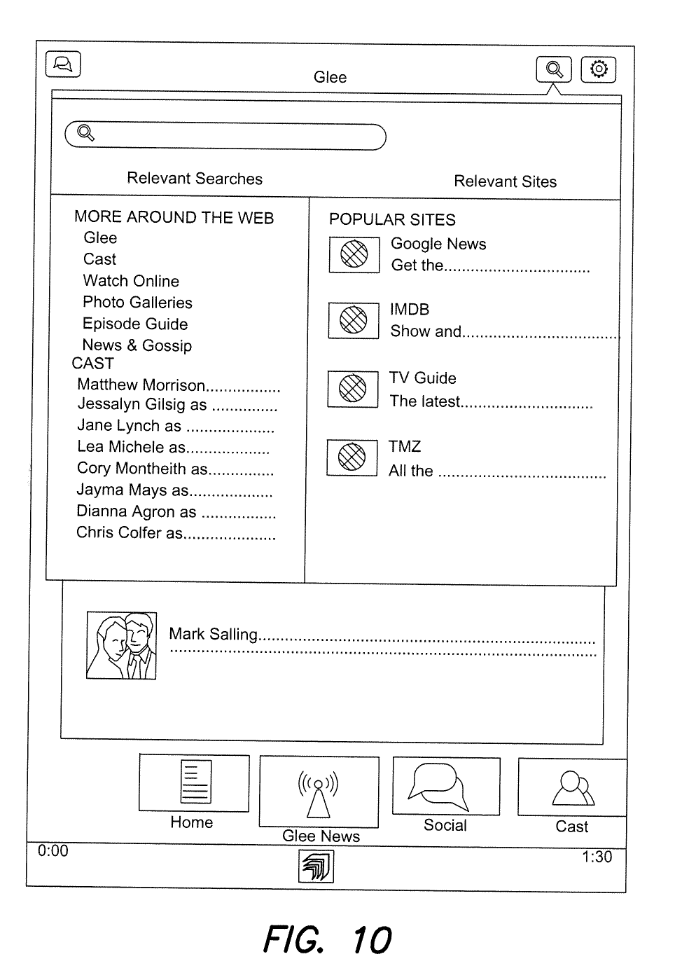

FIG. 10 is shown in response to the user selecting the search box. The search interaction, in this particular view, is imposed on top of the Glee News page, but is not per se part of the page. This interface has a search box at the top for the user to enter a search request. Below the search box the interface has windows that list possible relevant searches and sites for accessing further related content. One window lists options for searching on the web by category, such as “Glee”, “Cast”, “WatchOnline”, “Photo Galleries”, “Episode Guide”, and “News & Gossip”. Another window lists popular sites such as Google News, IMDB, TV Guide, and TMZ. Links are provided for connecting to each of the designated sites. Below these listings of relevant searches and sites is another window with text and images relating to the show and providing a link to other related content.

If the “Social” icon on FIG. 8 is selected by the user, the display as shown in FIG. 11 appears on the second screen. This interface provides the user with quick access to multiple third-party (not affiliated with the Second Screen Content Provider) social networking sites for viewing further related content. Across the top are four selection buttons entitled “Everyone”, “Official”, “Cast” and “Friends”. Arranged in serial order down the page are images and text from various social networking sites.

If the “Cast” icon is selected in FIG. 8, a user interface as shown in FIG. 12 appears on the second screen. The FIG. 12 interface is presented as a series of windows that a user can tap on and/or swipe through for viewing. The user can also click on links to additional related content concerning the cast members shown in each specified entry on the page.

Additional embodiments of the invention will now be described including specific implementations designed to enhance the viewer's experience of the primary and related content. These embodiments relate generally to: a) presenting webpages synchronizeronous to the viewer's location in the primary content; b) client-server fingerprint matching to enable identification of the primary content; c) continuous tracking of the primary content being viewed to enable more efficient identification of the primary content; and d) classification of primary content attributes for more efficient identification of the primary content and/or selection of related content.

One feature of the present invention is the ability to control when during a program viewing a page in the flipbook is shown to a user. In one embodiment, the SSCP utilizes an identifier (e.g., a live broadcast timecode) of the primary content and links the second screen (SS) presentation (of related content) to that identifier. The SS presentation is now synchronized to the primary content. However, the SSCP may also wish to monitor and control when individual flipbook pages are presented to each user. For example, a “quiz” page of the flipbook may pose a series of questions to viewers at specific moments in a program. If there are two viewers of a program, one watching live, and another watching time-shifted five minutes behind the live program airing, it is desired that the second viewer not see the questions on that page until five minutes after the first viewer. In one embodiment, a Javascript library enables a webpage developer to design a webpage that calls to retrieve a current timecode of the viewer in the program. An alternative approach is to provide a backend web service (e.g., provided by the SSCP) which posts a user's current program and timecode. Then, other web pages can call that service to determine where the user is in the program.

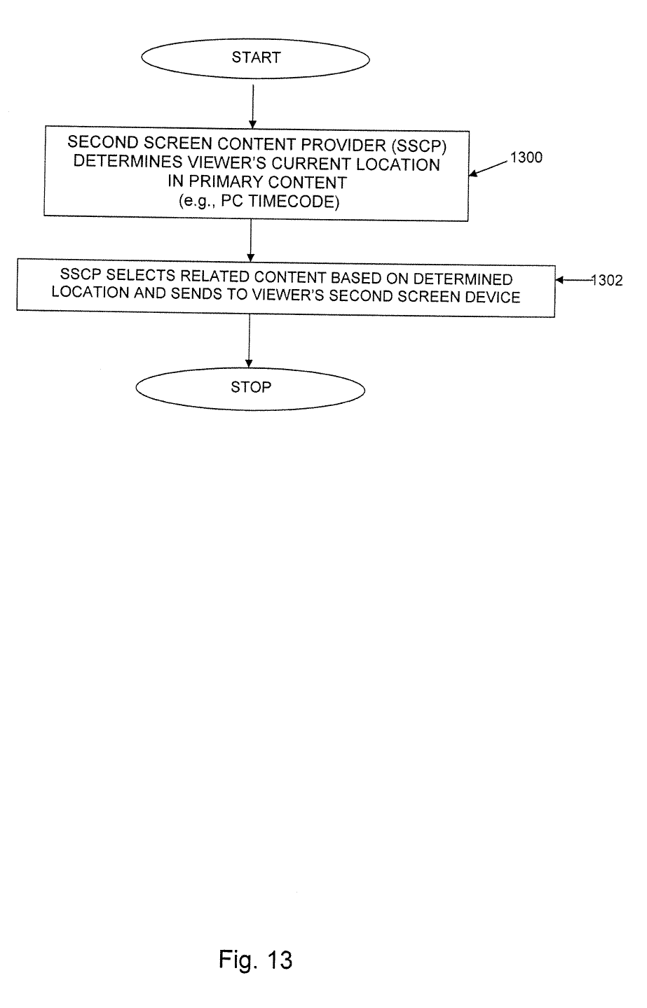

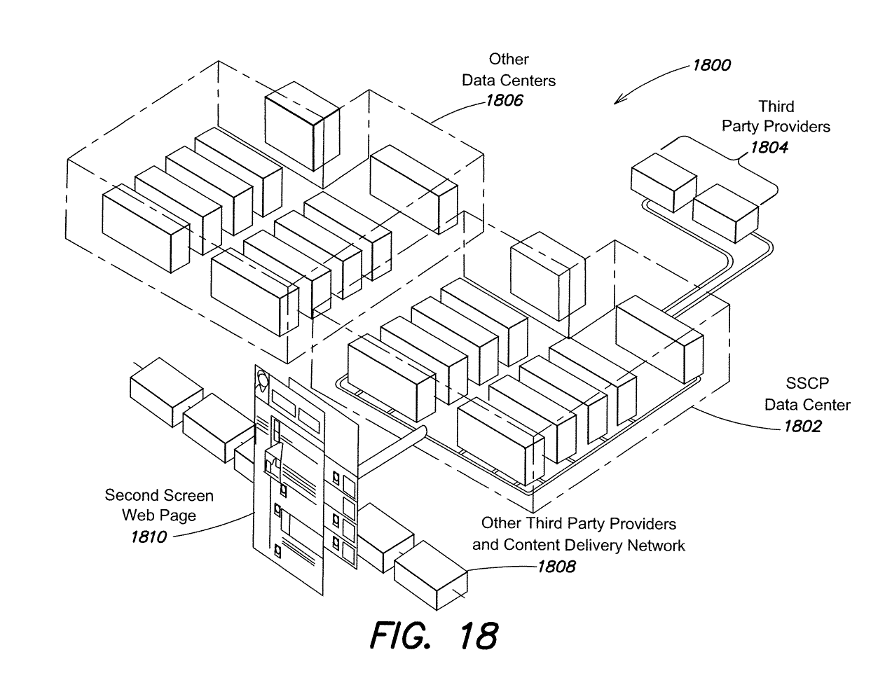

Referring now to FIG. 13, there is illustrated a flow chart of a process for the identification of primary content and selection of related content by the second screen content provider (SSCP). At 1300, the SSCP determines a viewer's current location in the primary content. For example, the SSCP may designate the viewer's current location based on a timecode, which may be the same as the timecode provided by the source of the primary content. Such timecodes typically start at time 0 when the program begins, and are incremented in seconds and minutes as the program content proceeds in time. At 1302, the SSCP selects related content based on the determined location and sends the related content to the viewer's second screen device. As used herein, the SSCP can select related content from preexisting stored content on the SSCP database or by identifying other available sources of related content that are not stored by the SSCP. In one embodiment the SSCP provides links to related content, and this content may be hosted in a variety of locations, e.g., some controlled by the SSCP and others not. The client second screen application then uses these links it receives from the SSCP to access the related content. Thus, as used herein “sends” is defined broadly and includes one or more of sending related content generated and/or stored by the SSCP on an SSCP controlled database and/or causing the related content to be sent from third-party providers to the viewer's second screen device and/or the SSCP sending the second screen (SS) device links (as identifiers) of the related content which the SS device uses to access and/or assemble the related content on the second screen. This process is discussed further below in relation to FIG. 18.

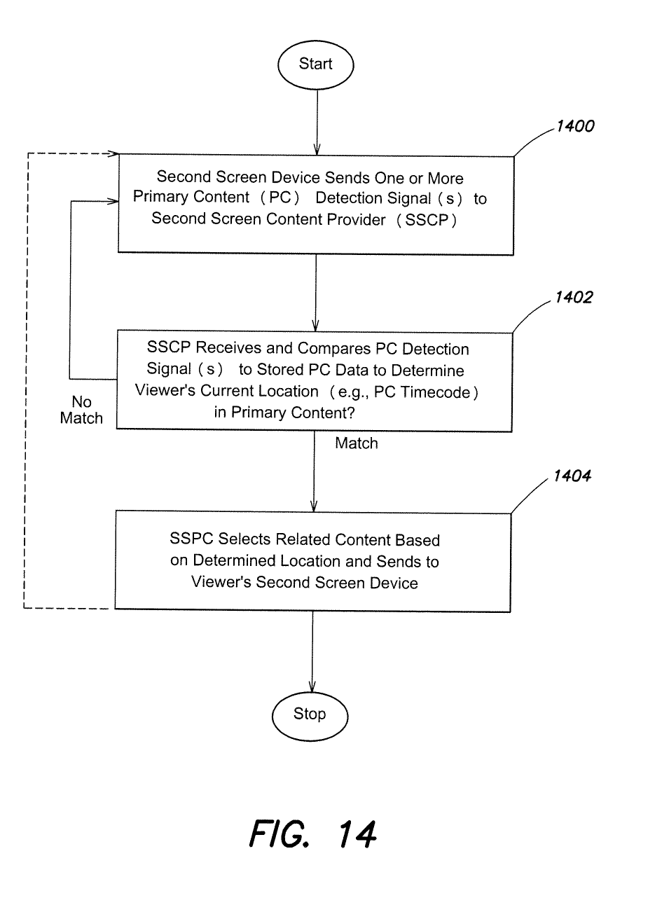

FIG. 14 illustrates a flow chart of another process for synchronizeronizing content based on the viewer's current location in the primary content. At 1400, a second screen device sends one or more primary content (PC) detection signal(s) to a second screen content provider (SSCP). At 1402, the SSCP receives and compares the PC detection signal(s) to the stored primary content data to determine the viewer's current location in the primary content. This current location may be designated by a PC timecode. If there is a sufficient match between the stored PC data and the signal(s) representing a viewer's current location in the primary content, the process proceeds to step to 1404 wherein the SSCP collects the related content based on the determined location and then send the related content to the viewer's second screen device. Alternatively, if there is no match, the SSCP awaits further SSCP detection signal(s) and again conducts the comparison step 1402 to determine the viewer's location.

As previously described, it may be beneficial for the SSCP to continuously track the viewer's location in the primary content, (e.g., via a primary content time identifier), in order to control the time of delivery of the related content. For this purpose, after step 1404 the process returns to step 1400 (see dashed line in FIG. 14).

It may also be desirable to provide a web-based fingerprint matching service in which each client, e.g., an iPad application on the viewer's second screen device, sends one or more fingerprints to the server of the second screen content provider (SSCP) in order to identify what the viewer is watching. The SSCP likely would desire a highly scalable backend service for conducting such fingerprint matching. Generally, the less state a web server has to store about an individual client application (user) the faster and better it will scale because the request can be handled by any one of multiple available servers without regard to previous requests. However, the activity must be coordinated across sequential request-response transactions. Thus, it may take several cycles for a client to accumulate enough information to distinguish the primary content. In one embodiment, the second screen application sends fingerprint data to the SSCP server periodically, e.g., every 2 to 4 seconds, with the expectation that it may take several, e.g., 3 to 5 such transactions (over a 6 to 20 second time period) to gather enough information to have a high quality fingerprint match to identify the primary content being viewed. The SSCP would like to minimize the amount of state its server(s) have to retain in order to provide this service. In one embodiment, the SSCP platform utilizes a cookie model. On a first request from the second screen application for identification of the primary content, the server attempts to find a match but may find a weak or incomplete match. The server reports to the client “no match” but stores the partial match information in a cookie which the server sends to the client. The client receives this cookie and saves it, sending it back to the server along with the next transmission of fingerprint data. The server then performs a match on this new query, combining in the comparison process the latest fingerprint data with the partial match information contained in the cookie. If a match is found of complete or high quality, the server then tells the client “match found”. If a match is still not found, then the server sends the updated partial information (now including the cumulative results of the two queries) back to the client, and the process continues.

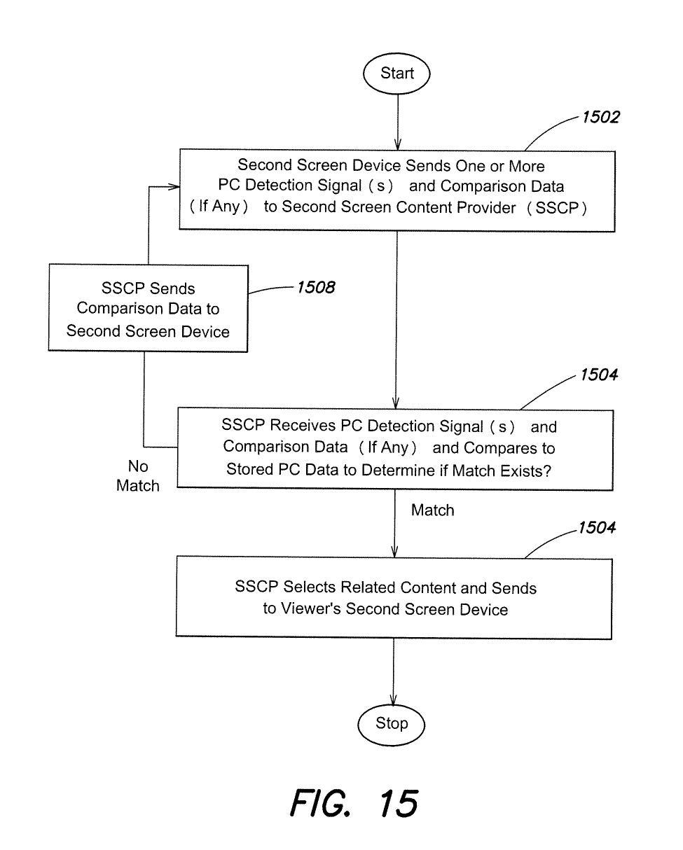

FIG. 15 illustrates one embodiment of this process. At 1502, the second screen device sends one or more primary content detection signal(s) and prior comparison data (if any) to the second screen content provider. At 1504, the SSCP receives and compares the detection signal(s) and comparison data (if any) to the stored PC data to determine if a match exists. If a sufficient match is found, at 1506 the SSCP selects the related content and sends the related content to the viewer's second screen device. If a sufficient match is not found, the SSCP sends the comparison data to the second screen device (e.g., as a cookie). The process returns to step 1502 wherein the second screen device then sends later PC detection signal(s) and the prior comparison data (of the cookie) to the SSCP.

According to another embodiment of the invention, a method is provided for more efficient fingerprinting services, for example that scales better to a large volume of users. In this process, during an initial primary content matching process, a search is conducted for a match across the entire database e.g., of stored primary content fingerprints. Once a sufficient match is found identifying the primary content being viewed, future searches for that user can be conducted within a subset of the database related to the initially identified primary content, thus reducing the processing load of subsequent searches on the fingerprinting service. In one example, the SSCP identifies what the viewer is watching (e.g., finds the program and timecode in the program), and then restricts future restrictions to a time window just beyond that timecode. This drastically reduces the search space. In another embodiment, future searches are restricted to plus or minus a specified amount of time (e.g., five minutes) to account for the fact that users may jump forward or backward using digital recording devices or services. In an alternative process, future searches are conducted at the second screen device, rather than at the SSCP server. Thus, once the SSCP server has made an initial identification of a program and a timecode, instead of the client sending future fingerprint data to the server for a match, the server starts sending the predicted fingerprints back to the client (second screen), and the client then performs a local verification of the primary content location. If the client cannot verify, then the whole search process may start again beginning with the initial determination at the server.

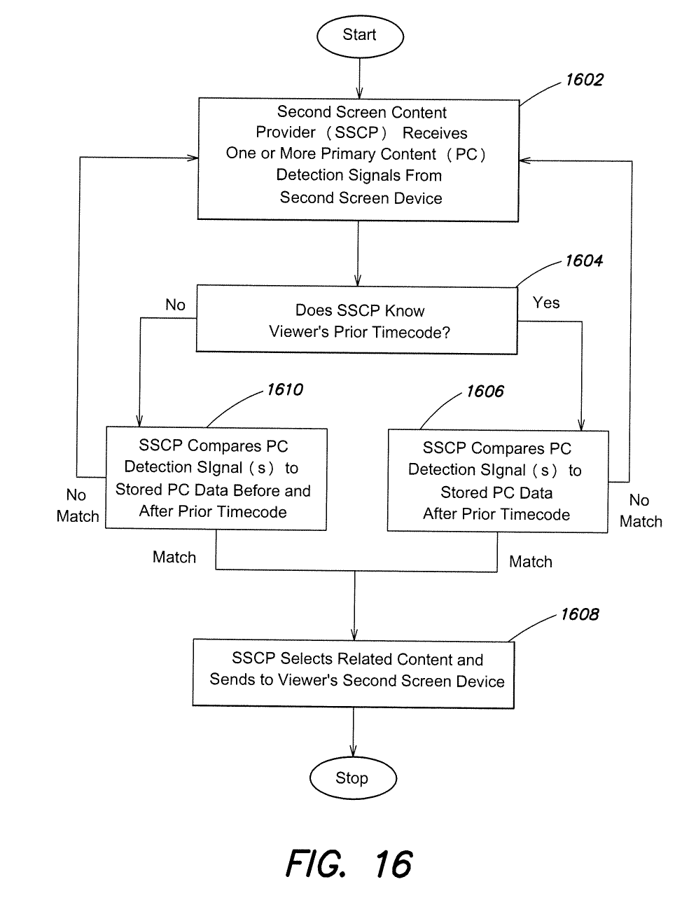

FIG. 16 illustrates one embodiment of this process. At 1602, the second screen content provider (SSCP) receives one or more primary content (PC) detection signals from the second screen device. At 1604, the SSCP determines whether it has made a prior determination of the viewer's location, e.g., does the SSCP know the viewer's prior timecode? If the answer is yes, at 1606, the SSCP limits the comparison of the PC detection signal(s) to the stored PC data for primary content after the viewer's prior timecode. If the answer is no, at 1610 the SSCP compares the PC detection signal(s) to the stored PC data both before and after the timecode. Once a match is found, at 1608 the SSCP selects the related content and sends the related content to the viewer's second screen device. If there is no match, the process returns to the initial step 1602.

In another embodiment of the invention, a system and method are provided for classifying different types of primary content detection signals to determine whether the content being detected is truly unique or whether it is ambiguous. More specifically, in a fingerprint-base content identification model, the SSCP is inferring what the viewer is watching by comparing it with a library of primary content data, using for example a symmetric fingerprint, i.e., the client and server compute fingerprints using the same algorithm. While the SSCP may have scheduling information about what primary content is being broadcast, e.g., on TV, this information is often not accurate to the minute or second, and it does not identify where commercials will occur. Furthermore, without prior collaboration with the TV networks and advertisers, which can be difficult to arrange, the SSCP may not know beforehand the fingerprint signatures that the primary content will generate until the content is broadcast and publically available. Finally, much of the primary content, such as TV content, is repetitive. TV shows are often broadcast multiple times, commercials are aired repetitively across many networks, and TV shows use theme songs which may occur many times on the show. As a result of these factors, it is often ambiguous what a viewer is watching based on fingerprints alone.

What is needed is a system that can predict whether a piece of content is truly identifying (unique) or whether it is ambiguous. In one embodiment, this determination is made based on live and accumulated broadcast content. If it is determined that something is identifying, then the related content is determined and sent to the client. However, if it is ambiguous, the second screen content provider defers providing related content until an identification can be made (it is no longer ambiguous).

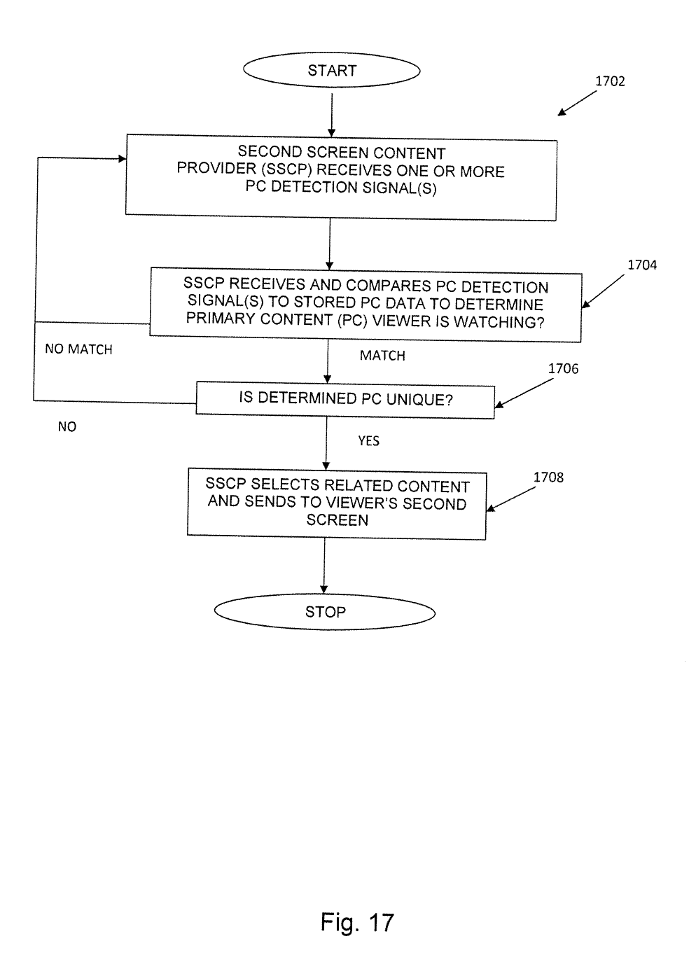

FIG. 17 illustrates one embodiment of this process. At 1702, the second screening content provider (SSCP) receives one or more primary content detection signal(s). At 1704, the SSCP receives and compares the PC detection signal(s) to stored PC data to determine what primary content the viewer is watching. If a match occurs, at 1706 a further determination is made, namely whether the determined PC is unique. If the answer is yes, the SSCP selects the related content and sends it to the viewer's second screen at 1708. If not, the process returns to step 1702, where the second screen content provider receives additional PC detection signals.

According to one embodiment, the SSCP accumulates and classifies content as follows. The SSCP receives content (e.g., a live broadcast, streaming, DVD, file, etc.), and as the content comes in, the SSCP classifies the content as it is added to the library. In one embodiment, the SSCP labels and stores the content attempting to classify it into one of a plurality of categories, e.g.:
unique, never before seen content (e.g., probably a program segment);
advertising;
program segment that has been previously aired before (repeat airing);
repetitive program segment (e.g., a theme song).

The content may be classified into these and other categories based on a number of attributes, for example:
how many times has the content previously occurred; e.g., lots of repetition indicates a high likelihood of it being an advertisement;
what is the length of the repetitive segment; for example, a 15 or 30 second repetitive segment indicates an advertisement;
has it only occurred on this network or on other networks; if only on this network, it may be a program promotion for another show on that network;
has it only occurred for a previous airing of this program and in approximately the same location (according to previously published broadcast schedule); if so, then the user probably is watching one of multiple airings of the same show.

In another embodiment, the SSCP uses previously classified advertisements, or produces fingerprints from sample advertisements (e.g., provided by a third-party source) to locate the edges (i.e., beginning and ending) of a TV program. If the SSCP knows all of the advertisements in a program, then by subtraction the second screen content provider can find the program segments between by those advertisements.

There are a number of potential advantages that result from listening to and classifying live broadcasts. One advantage of classifying content into one of several buckets (e.g., advertising, programming) is that this helps to perform faster, more accurate content recognition (i.e., determine what content the viewer is watching on the primary device). Secondly, extracting information related to the broadcast (e.g., cast information, keywords, products, texts/titles on screen) provides insights into what additional (related) content to show the user.

For example, in one embodiment the SSCP utilizes multiple content streams, e.g., video, audio, closed captioning, to generate metadata that can be used to improve the quality of the matching and/or selection of related content process step(s). The SSCP backend servers (ingestion servers) have access to the video and closed captioning content of the programming (primary content) from which the SSCP can extract information (e.g., images from the video and text from the closed captioning). Also, the ingestion servers presumably receive a cleaner audio signal that the SSCP can use to extract additional information for use in generating related content. Typically, the client signal (detected from the primary device) will be noisy (e.g., include ambient noise in the user's environment such as noise generated by air conditioners, traffic, conversations, etc.). Preferably, a fingerprinting algorithm is used that can detect the more prominent distinctive characteristics (versus the noise) of the audio signal from the primary device, for use in the matching process. However, the fingerprint generated from the primary device may contain significantly less informational content than the stored fingerprint generated by the SSCP backend ingestion servers. Thus, by using the stored (cleaner) signal the SSCP can facilitate the matching process, e.g., utilize the metadata from the stored signal to assist in classifying the incoming detection signal and determining whether it is a unique or ambiguous signal (e.g., relates to an advertisement or is a repetitive segment relating to a theme song, etc.) Also, the stored metadata can be used for determining additional related content for sending to the second screen device.

FIG. 18 is a block diagram of a system for delivering and assembling a page to a second screen user device wherein the content is assembled from multiple sources. The multiple sources may include: an SSCP data center 1802, third-party providers 1804, other data centers 1806, and other third-party content providers and content delivery network 1808, all of which are in network communication to deliver content for a second screen webpage 1810. The SSCP data center may include web servers in which data from other servers in the center 1802 is assembled and formatted to the HTML that makes up a webpage. Frequently accessed content may be stored in cache servers for faster retrieval. Other servers in the center 1802 may store news feed posts received from other providers 1804. This data may be filtered and assembled into a chronological list. Other servers in data center 1802 may store user information, e.g., text-based data about the users such as user identification and information concerning their friends, likes and interest. Other servers may contain tracking logs for monitoring user activity. Other servers may store images used in assembling the second screen pages. The center 1802 may also include the servers identified in FIG. 1, as the SSCP backend systems 120, including systems 122, 124, 126, 128, 130, 132 and 134.

The third-party providers 1804 may supply data from external sources to the SSCP data center 1802. The other data centers 1806 may share information directly or indirectly with the SSCP data center 1802, allowing for load balancing and rapid synchronization of user data. The other third-party related content providers and content delivery network 1808 includes commercial services that store and distribute web pages to users so that the data centers do not become bottlenecked, and/or provide related content that is selected by the SSCP for inclusion in the second screen web page 1810.

The previously described methods may be implemented in a suitable computing environment, e.g., in the context of computer-executable instructions that may run on one or more computers. In for example a distributed computing environment certain tasks are performed by remote processing devices that are linked through a communications network and program modules may be located in both local and remote memory storage devices.

A computer may include a processing unit, a system memory, and system bus, wherein the system bus couples the system components including, but not limited to, the system memory and the processing unit. A computer may further include disk drives and interfaces to external components. A variety of computer-readable media can be accessed by the computer and includes both volatile and nonvolatile media, removable and nonremovable media

The second screen device may be a wired or wireless device enabling a user to enter commands and information into the second screen device via a touch screen, game pad, keyboard or mouse. In the disclosed embodiment, the second screen device includes an internal microphone for detecting the primary content being watched or heard by the user from the primary content device. The second screen device includes a monitor or other type of display device for viewing the second screen content. The second screen device may be connected to the SSCP via a global communications network, e.g., the Internet. The communications network may include a local area network, a wide area network or other computer network. It will be appreciated that the network connections shown herein are exemplary and other means of establishing communications between the computers may be used.

### Further Embodiments

### Generating Fingerprints of Primary Content

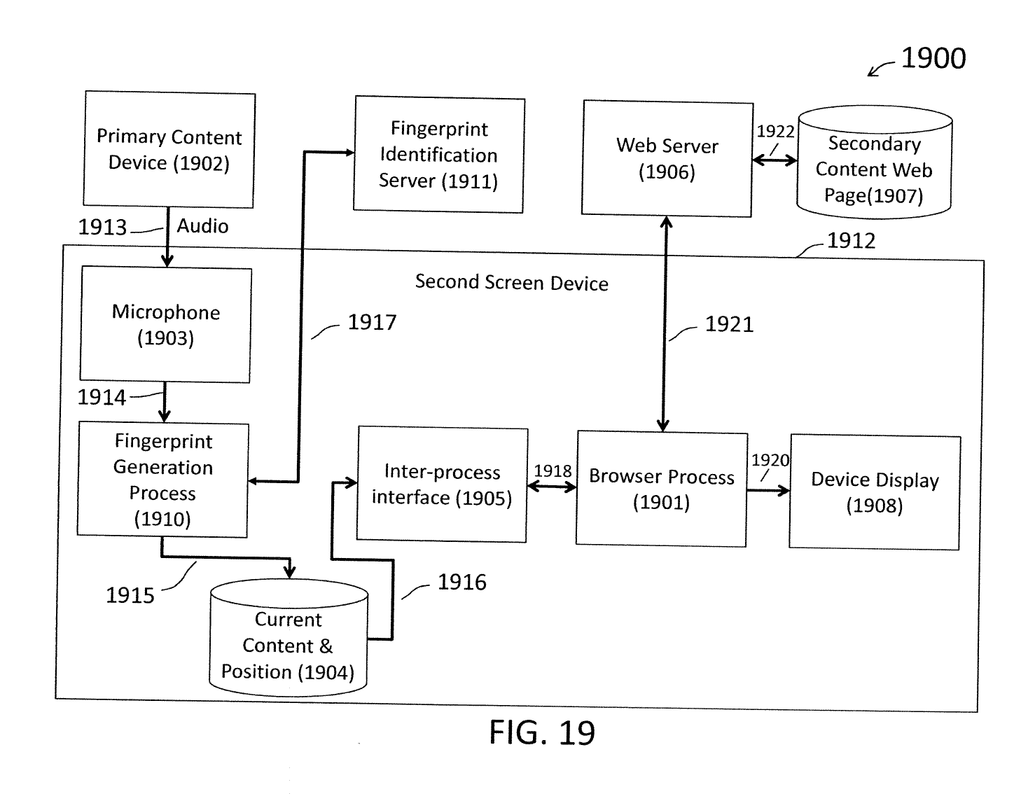

In one embodiment, a method of generating fingerprints and associated information of the primary content includes obtaining (e.g. licensing from one of several vendors) television broadcast schedule information. For a particular broadcast program or series of programs, time slices of the audio signal are captured along with the time of capture. For each audio signal time slice there is produced a fingerprint, and for each fingerprint an associated program that is airing at the time of capture and the relative time within the program. Each fingerprint and its associated program and time offset information is stored in a data store (such as a database). The data store, and a program for generating the primary content fingerprints and associated information and for determining a match (between a detected primary content and the stored primary content), may be external to the second screen device as described in the embodiments of FIGS. 19-22. In such embodiments, the second screen device acts as a client to an external server or web service providing one or more of: the data store of primary content and its associated information, the fingerprinting identification process, and the secondary content associated with the primary content for display on the second screen device.

Thus, when a second screen device (client) captures (detects) an audio portion of a primary content presented on a first screen device, and generates a fingerprint of that detected content, the detected fingerprint (and associated information, if any) is sent to the external fingerprint identification process for determining a match. Along with a match, the external service returns to the client the program and time offset information associated with the match, which again can be stored locally (on the second screen device) or remotely (external to the second screen device).

In other embodiments, the metadata associated with a match can be further extended to include linking the program to other information such as a Twitter or Facebook conversation occurring around the program, articles or photos associated with the program, etc.

### FIG. 19

FIG. 19 illustrates one embodiment of the invention wherein a second screen device includes a web browser. The system 1900 includes a second screen device 1912 and external thereto a primary content device 1902, fingerprint identification server 1911, web server 1906 and secondary content web page 1907. Internally the second screen device includes a microphone 1903, fingerprint generation process 1910, current primary content and position data store 1904, inter-process interface 1905, browser process 1901 and device display 1908.

The primary content (first screen) device 1902 presents video programming to a user, which includes an audio signal transmitted via air 1913 that is captured (detected) by the microphone 1903 of the second screen device.

The microphone 1903 transmits the detected (optionally processed) audio signal on a communication channel 1914 to a fingerprint generation process 1910 for generating a fingerprint of the detected audio signal using the same fingerprinting algorithm used for generating fingerprints of known primary content. The fingerprinting process 1910 communicates via channel 1917 with an external identification server 1911 for determining a match. Once a match has occurred the process 1910 transmits on channel 1915 certain match data to data store 1904, such as the current (detected) primary content and time offset within the detected program. That data is then available via channel 1916 to an inter-process interface 1905, which communicates via channel 1918 with the browser process 1901 to determine an associated secondary (related) content for presentation on the second screen display 1908. The browser 1901 communicates on channel 1921 with an external web server 1906 for supplying via channel 1922 relevant secondary content web pages 1907. The web pages sent to the browser 1901 can then be associated with the current program and position (time offset) information for presentation on the display screen 1908, e.g., as a series of time synchronized pages.

In one embodiment, the inter-process communication interface 1905 is a Javascript library, a browser plug-in, or other interface. The web browser 1901 receives web pages from web server 1906 in response to various events (e.g., an application starting, an event on the second screen device, or some user interaction on the second screen display), and executes the Javascript or other dynamic web scripts that are embedded on the page. One of these scripts may call for an interaction with the custom Javascript library that accesses the information stored by the fingerprinting process. The browser then takes an action conditional on this information, which may include presenting current information differently, or retrieving new secondary content from the same web server 1906 or from another web server. The browser may then present the secondary content to the user via the display screen 1908.

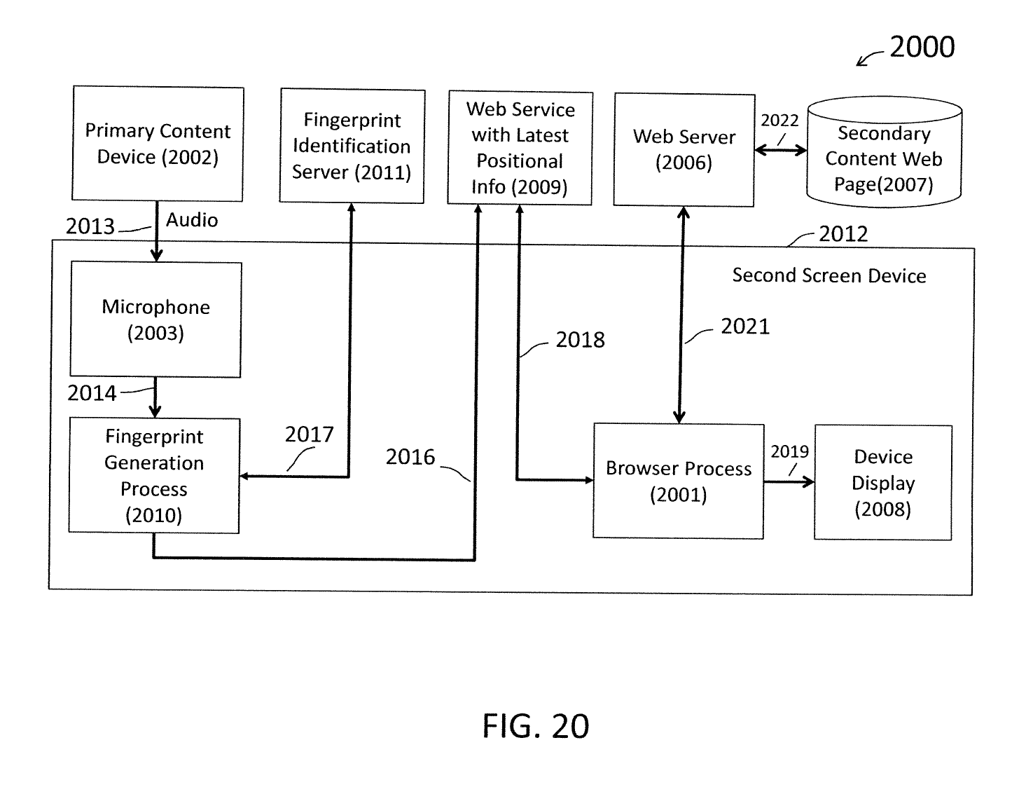

### FIG. 20

FIG. 20 illustrates another embodiment of the invention similar to the embodiment shown in FIG. 19 except the fingerprinting process posts the primary content program and positional information to a web service that is also available to the browser process on the second screen device.

More specifically, system 2000 is illustrated including a second screen device 2012 and external thereto a primary content device 2002, fingerprint identification server 2011, web server 2006 and secondary content web page 2007, all of which are comparable to the similarly defined elements in FIG. 19. In addition, an external web service with the latest positional information 2009 is provided and communicates via channel 2016 with the fingerprinting generation process 2010 on the second screen device, and via channel 2018 with the browser process'2001 on second screen device. Thus, instead of the fingerprinting generation process storing the current positional information locally on a data store on the second screen device, in this embodiment the information is stored externally on the web service 2009. Otherwise, the primary content transmitted via channel 2013 to microphone 2003 and then via channel 2014 to the fingerprint generation process 2010, operates similarly to FIG. 19, and the browser process 2001 of FIG. 20 communicating via channel 2019 with second screen display 2008 and also communicating via channel 2021 with external web server 2006 which communicates in turn via channel 2022 with secondary content via web page 2007, all operate similarly to FIG. 19.

In the embodiment of FIG. 20, the fingerprint generation process 2010 acts as a client to the external web service 2009, and the information posted to the web service includes both the detected program content and positional information, as well as a unique identifier for the second screen device 2012. When a web page with a need for program and positional information is executed, it obtains the stored content and positional information from the web service 2009, which web service can be shared by a plurality of clients (each having a unique identifier), instead of from a data store on the second screen device (e.g., data store 1904 in FIG. 19).

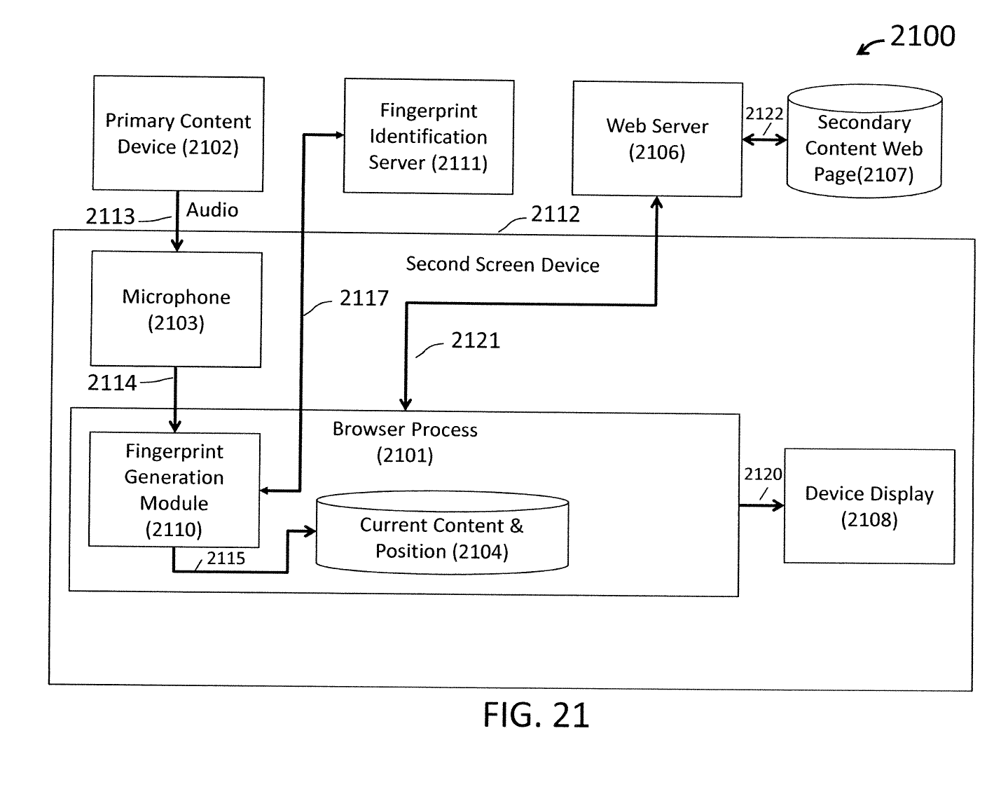

### FIG. 21

The embodiment illustrated in FIG. 21 operates similar to the embodiment of FIG. 19 except that the fingerprinting process is embedded directly into the browser. The system 2100 illustrated in FIG. 21 includes components which correspond with those in FIG. 19 and have been similarly labeled except for use of reference numbers in a 2100 series, versus a 1900 series. As noted, in FIG. 21 the browser process 2101 includes embedded therein a fingerprint generation module 2110 and a data store 2104 of current content and positional information. Thus, instead of communicating with an external process, the current content and positional information is instead available through the browser process 2101.

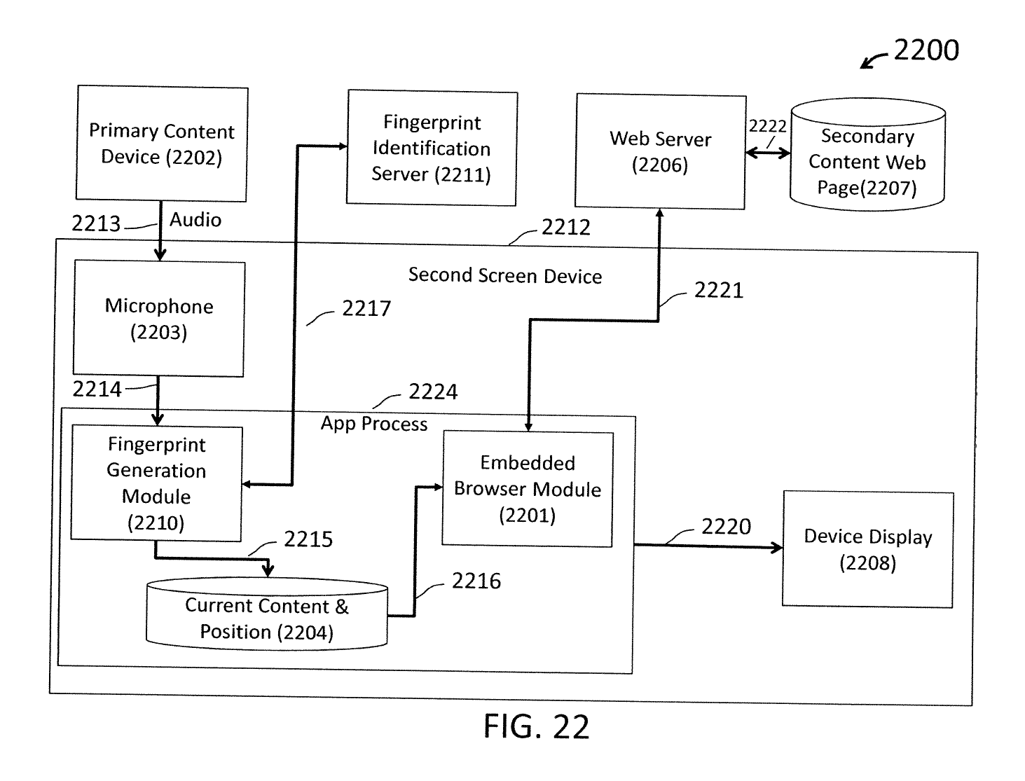

### FIG. 22

FIG. 22 illustrates another embodiment similar to the embodiment of FIG. 19 but wherein a primary application embeds both the fingerprinting process and web browser. The system 2200 includes a second screen device 2212 having an application process 2224 in which is embedded a fingerprint generation module 2210 communicating on channel 2215 with a data store of current content and positional information 2204, which in turn communicates on channel 2216 with embedded browser module 2201. Otherwise the components of the system 2220 are comparable to those set forth in FIG. 19 but designated with reference numbers in a 2200 series, versus a 1900 series.

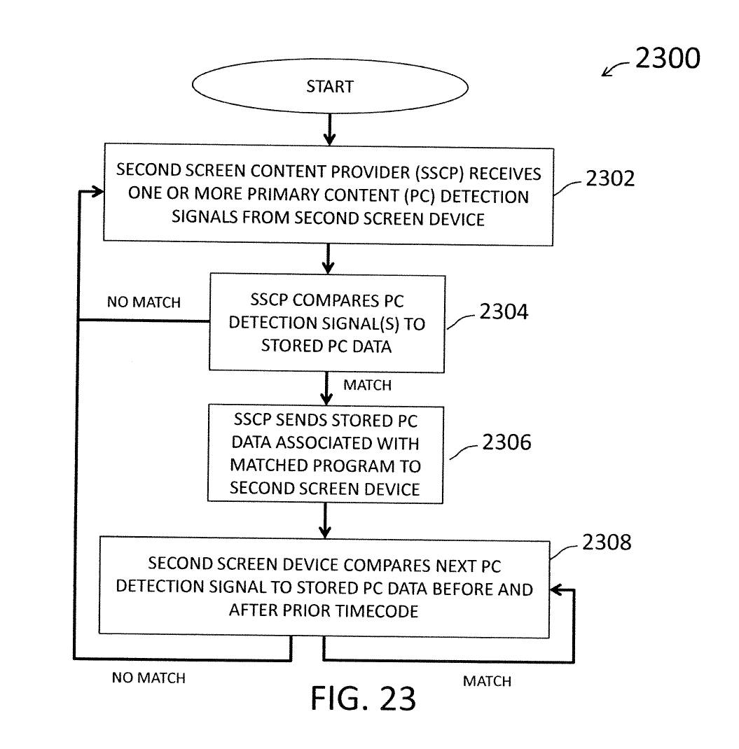

### FIG. 23

FIG. 23 illustrates a flow chart of another embodiment in which an external process pushes the associated fingerprint data for a match down to the second screen device, including data within a neighborhood of the match to enable subsequent comparisons to be processed locally on the second screen device, e.g., until a subsequent match fails, and then the process begins all over again. In the process 2300, a second screen content provider (SSCP) external to the second screen device receives one or more Primary Content (PC) detection signals from the second screen device, in step 2302. In a next step 2304, the SSCP compares the PC detection signal(s) to PC data stored externally to the second screen device. If a match is found, the SSCP sends the stored PC data associated with the match (e.g., including program and time offset) to the second screen device, at step 2306, along with fingerprint data for a neighborhood covering a time period both prior to and after the match (e.g., ±5 minutes), for storage on the second screen device. In a next step 2308, the second screen device compares the next PC detection signal to the now locally stored PC data before and after the prior time code. If a match is found, the second screen device continues in this mode comparing the next detection signal to the locally stored data. If no match is found, the process returns to the first step 2302, wherein the external SSCP begins searching the entire data store for a match. Similarly, if no match is found in the second step 2304, the process continues to the first step until a match is found or the data store is completely searched.

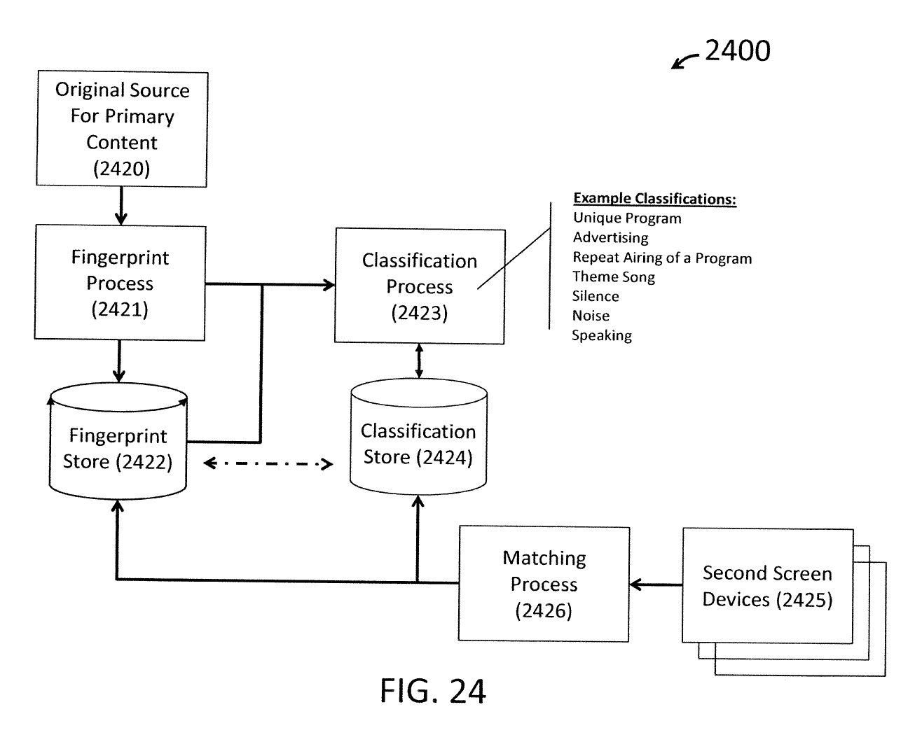

### FIG. 24

FIG. 24 illustrates a further embodiment in which classification data can be used to enhance the fingerprinting identification process. Primary content 2410 (e.g., from an original source) is fingerprinted according to fingerprint process 2421. The results of the fingerprinting process are then stored 2422. The results are also passed to a classification process 2423. Using these results, as well as fingerprints from prior primary content in 2422 and classifications from prior primary content in 2424, the classification process makes determinations about the nature of the content and stores it in the classification store 2424.

Various classifications can be used to simplify and/or speed the identification (matching) matching process, for example:
Unique Program;
Advertisements;
Repeat airing of a Program;
Theme Song;
Silence;
Noise; and
Speaking.

The use of such classifications may also vary. In one embodiment of the classification process, if the current content matches a prior fingerprint that has already been labeled as an advertisement, then the current content is also classified as an advertisement. In another embodiment, if the current content matches a different episode of the claimed program, it is labeled as a theme song or repetitive program element. In another embodiment, if the current content does not match any prior fingerprints, it is classified as unique programming.

At a later time, when content is received from a second screen device 2425, a matching process 2426 attempts to find a match within the fingerprint store 2422. If a match occurs, the matching engine retrieves the classification information associated with the same content from within the classification store 2424. In one embodiment, if the matching engine finds a match within content classified as an advertisement, it may communicate to a second screen device that for example, no match has occurred (assuming this is not a primary content of interest to the user of the second screen device), or alternatively that a match to an advertisement has occurred. In another embodiment, if a matching engine finds a match with a theme song, it may communicate to a second screen device that a known program is being viewed, but it is not clear what episode is being viewed.

In one or more embodiments described herein, various programming languages can be used as would be apparent to those skilled in the art for accomplishing the functionality described herein. By way of example only, where the second screen device comprises a mobile or tablet device, suitable programming languages may include Objective C, C++, and Java. For Internet services, suitable programming languages may include Java, Python, MySQL and Perl. For ingesting the primary content (e.g., capturing and generating audio fingerprints), the programming languages may include Java, Python, and MySQL.

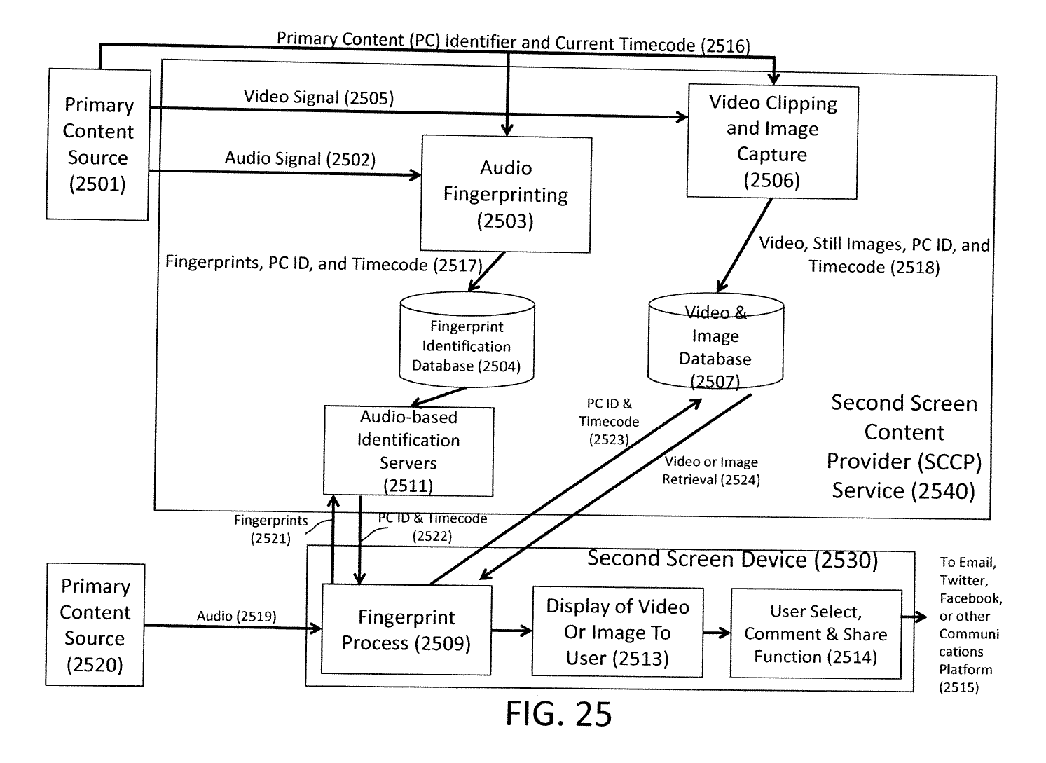

### FIG. 25

FIG. 25 illustrates a system that allows users of an audio-synchronized second screen interactive platform to share images or video from specific moments in a TV show. The systems consists of a second screen content provider (SCCP) 2540, a second screen device 2530, a primary content source 2501 for the SCCP, and a primary content source 2520 for the second screen device.

The primary content source 2501 consists of an audio signal 2502, a video signal 2505, and a unique primary content (PC) identifier (ID) and current timecode 2516. The audio signal 2502 is fingerprinted 2503 and the resulting fingerprints, PC ID, and timecode 2517 are stored in a fingerprint identification database 2504. Simultaneous to the audio process, the video signal 2505 and current PC ID and timecode 2516 are captured and processed 2506. Short segments of video, still images, PC ID, and timecode 2518 are stored in a video and image database 2507.

A second screen device 2530 is used in conjunction with a primary content source 2520. Audio 2519 is received by the second screen device and fingerprinted 2509. The second screen sends fingerprints 2521 to audio identification servers 2511 of the SCCP. If a match is found, a corresponding PC ID and Timecode 2522 are returned. The same PC ID and Timecode are then sent (2523) to the video and image database 2507 of the SCCP, and an associated set of videos and/or images from that PC and neighboring timecodes are returned 2524.

The second screen may then display these images and videos to a user 2513. The user may then select an image or video, add a comment, and share them (2514). The image or video and comment may then be delivered to other people via email, Twitter, Facebook or other similar communications protocol or social network 2515. In various embodiments, the invention includes:
A system that captures audio from a primary content source, generates fingerprints from that audio, and stores those fingerprints with an associated content identifier and timecode; at the same time, the system captures video and still images from the same moments in the primary content source, and stores them with the same associated primary content identifier (PC ID) and timecode.
A system that receives audio fingerprints from a second screen device, matches those fingerprints with a primary content in its library, and returns the PC ID and timecode associated with those fingerprints; in addition, the system sends (or responds to a request from the second screen device to send) video and/or images from a database of video and images previously captured and associated with that PC ID and timecode; the video and images may directly correspond to the requested timecode, or may be within a certain designated time range before and after that timecode.
A system that then enables a user to select one or more images or videos, comment on them, and share them via email, Twitter, Facebook or other similar communications protocol or social network.

What has been described above includes examples of the present invention. It is, of course, not possible to describe every conceivable combination of components or methodologies for purposes of describing the present invention, but one of the ordinary skill in the art may recognize that many further combinations and permutations of the present invention are possible. Accordingly, the present invention is intended to embrace all such alternations, modifications and variations that fall within the present disclosure and/or claims. Furthermore, to the extent that the term “includes” is used in either the detailed description or the claims, such term is intended to be inclusive in a manner similar to the term “comprising” when employed as a transitional word in a U.S. claim.

1. A second screen interactive content delivery system comprising:
a portable interactive second screen device for use while watching a primary content comprising television programming on a first screen device, the second screen device having an audio analyzer for audibly detecting an audio portion of the currently viewed primary content on the first screen device and the second screen device having an interactive display screen for presenting interactive content contextually related to the detected primary content,
the second screen device including a processor executing a first stored program for communicating with an identification process that determines a match between a detected primary content and a known primary content, wherein the first stored program operates to:
process the detected audio portion and communicate the processed audio portion to the identification process to determine a match that identifies the detected primary content; and
based on that identification, process and present on the display screen an interactive content that is contextually related to the detected primary content.

2. The system of claim 1, wherein the first stored program utilizes a fingerprinting algorithm for processing the detected audio portion.

3. The system of claim 2, wherein the known primary content comprises fingerprints and for each fingerprint an associated television program and a time offset within the program.

4. The system of claim 1, wherein the interactive content is presented as a series of web-based pages synchronized in time with respect to the detected primary content.

5. The system of claim 4, wherein the series of pages are synchronized to time codes in the television programming.

6. The system of claim 4, wherein the series of pages can be scrolled via the interactive display screen.

7. The system of claim 4, wherein individual pages can be selected via the interactive display screen.

8. The system of claim 5, wherein the series of pages comprises a flipbook, organized horizontally, vertically or stacked, and in order of the time codes.

9. The system of claim 4, further including the presentation of one or more asynchronous pages at the beginning and/or end of the series of synchronized pages.

10. The system of claim 5, wherein the first stored program operates to automatically after a designed time period, or in response to a communication from a user selectable option on the display screen, return to a page having a time code closest to but not exceeding a current time.

11. The system of claim 5, wherein each page is displayed only after its associated time code has passed in the primary content being detected.

12. The system of claim 5, wherein the first stored program operates to conceal a page until after its associated time code has passed in the primary content begin detected, and presents a user selectable option on the display screen to reveal the page.

13. The system of claim 1, wherein the first stored program operates to automatically advance through the time synchronized pages presented on the interactive display screen.

14. The system of claim 13, wherein the first stored program halts the automatic advancement in response to an input signal from the display screen indicating a user interaction with the display screen.

15. The system of claim 1, wherein the first stored program communicates as a client with a fingerprinting identification server external to the second screen device for determining a match of a detected primary contact and a stored primary contact.

16. The system of claim 15, wherein the client and server accumulate and share matching information over several request-response transactions to determine a match.

17. The system of claim 16, wherein the server executes a second stored program that sends a cookie to the client with partial match information.

18. The system of claim 17, wherein the first stored program receives the cookie and sends the cookie back to the server along with a subsequently detected audio portion.

19. The system of claim 1, wherein the first stored program communicates with a fingerprinting identification service to search for a match across a data store of known primary content, and once a match is identified, subsequent searches for matches with subsequent detected audio portions are performed within a neighborhood of the identified match.

20. The system of claim 19, wherein the neighborhood is a range of time prior to and after to the matched primary content.

21. The system of claim 1, wherein the second screen device is Internet-enabled for communicating with the identification process and source(s) of the interactive content.

22. The system of claim 1, wherein the second screen device includes a browser process communicating with an external web server for aggregating the interactive content.

23. The system of claim 1, wherein the second screen device includes a web browser, a data store of detected primary content, and an inter-process interface communicating with the browser and data store for processing the interactive content.

24. The system of claim 1, wherein the first stored program on the second screen device includes a fingerprinting generation process communicating with an external web service that stores detected primary content.

25. The system of claim 1, wherein the second screen device includes a browser process having a fingerprinting generation process embedded in the browser process.

26. The system of claim 1, wherein the second screen device includes a fingerprinting process and a browser process embedded in a primary application stored on the second screen device.

27. The system of claim 1, wherein the identification process utilizes metadata of the known primary content and the detected audio portion to determine a match.

28. The system of claim 27, wherein the metadata comprises a characteristic of the known primary content including one or more of:
Unique Program;
Advertising;
Repeat Airing of a Program;
Theme Song;
Silence;
Noise;
Speaking.

29. The system of claim 27, wherein the first stored program utilizes the metadata to determine one or more of:
a program boundary;
an advertisement boundary.

30. The system of claim 1, wherein the first screen device comprises a television, a personal computer, a Smartphone, a portable media player, a cable or satellite set-top box, an Internet-enabled streaming device, a gaming device, or a DVD/blue ray device.

31. The system of claim 1, wherein the second screen device comprises a tablet computer, a Smartphone, a laptop computer, or a portable media player.

32. The system of claim 19, wherein the second screen device continually tracks the detected audio portion and the first stored program presents in substantially real time interactive content which changes as the detected audio portion changes.

33. The system of claim 32, wherein once a match is determined the identification service sends a portion of the data store defined by the neighborhood to the second screen device which portion is then stored on the second screen device for use locally on the second screen device in subsequent identification searches.

34. The system of claim 1, wherein the second screen device includes a user selectable input and the first stored program responds to a communication from the user selectable input to advance through the time synchronized pages.

35. The system of claim 34, wherein the first stored program operates to process communications from the user selectable input including one or more of:
requesting more information;
conducting a search;
viewing advertisements;
scheduling a future event;
contributing to the interactive content;
interacting with other viewers and/or non-viewers having an interest in the primary or interactive content;
social networking associated with the primary or interactive content;
purchasing services or goods.

36. The system of claim 1, wherein the primary content comprises a live broadcast, streaming content, or stored video content.

37. The system of claim 1, wherein the interactive content comprises one or more of a direct connection to a web page, and a link to a web page.

38. A method for substantially real time comparison and recognition of what primary content a viewer is watching on a first screen device comprising:
a. detecting on a portable interactive second screen device an audio signal from a primary video content that a viewer is watching on a first screen device;
b. identifying the primary video content utilizing the detected audio signal or a representation thereof for comparison with a primary content detection signal or representation thereof;
c. based on the identification, presenting content on the second screen device substantially synchronous to the viewer's location in the primary content.

39. The method of claim 38, including utilizing metadata of the primary content detection signal or representation thereof in the step of identifying the detected primary content or in a step of selecting the content presented on the second screen device.

40. The method of claim 39, including the step of extracting information from one or more content streams to generate the metadata.

41. The method of claim 40 wherein the streams comprise one or more of video, audio and closed captioning of the primary content.

42. A method of substantially real time sharing of video content a viewer is watching on a first screen device comprising:
a. detecting on a portable interactive second screen device an audio signal from a primary video content that a viewer is watching on a first screen device;
b. identifying the primary video content utilizing the detected audio signal or a representation thereof for comparison with a primary content detection signal or representation thereof;
c. based on the identification, presenting content on the second screen device substantially synchronous to the viewer's location in the primary content;
d. the content presented on the second screen device including one or more images or videos from the primary content that are substantially synchronous in time to the viewer's location in the primary content and a user selectable input for sharing the content via a social network, email or other communications protocol.

43. The method of claim 42 including
e. storing audio fingerprints of the primary video content in a data store with an associated content identifier and time code that identifies a location in the primary content;
f. storing video and/or images from the primary content in a data store with an associated content identifier and time code that identifies a location in the primary content; and
g. utilizing the audio fingerprints in the identifying step and utilizing the video and/or images that correspond to the time code of the identified audio fingerprint or within a designated time range before and/or after that time code to select the content presented on the second screen.
